(19) United States
(12) Patent Application Publication
(10) Pub. No.: US 2018/0037474 A1
(43) Pub. Date: Feb. 8, 2018

(54) MICROWAVE ABSORBING CARBON-METAL OXIDES AND MODES OF USING, INCLUDING WATER DISINFECTION

(71) Applicant: Board of Regents, The University of Texas System, Austin, TX (US)

(72) Inventors: Navid B. Saleh, Austin, TX (US); Jaime Plazas-Tuttle, Austin, TX (US)

(21) Appl. No.: 15/230,041

(22) Filed: Aug. 5, 2016

(51) Int. Cl. C02F 1/30; B01J 21/18; C02F 1/72; B01J 37/08; C01B 15/027; B01J 23/10; B01J 35/00

(52) U.S. Cl. CPC C02F 1/302; B01J 23/10; B01J 21/18; B01J 21/185; B01J 35/0006; B01J 35/0013; B01J 37/08; C01B 15/027; C02F 1/725; C02F 2305/023; C02F 2303/04

(57) ABSTRACT

Microwave absorbing materials are provided herein. Disclosed microwave absorbing materials include those comprising metal oxide nanocrystals hybridized to a carbon nanomaterial. Methods for making and using microwave absorbing materials are also disclosed, such as for generation of reactive oxygen species and disinfection of water.

### BACKGROUND

Ensuring water safety via disinfection has largely relied on the use of oxidants. Commonly used oxidants include chlorine, chlorine dioxide, and ozone. Ammonia can be added simultaneously or consecutively with chlorine to form chloramines, which is a less effective, but more persistent disinfectant as compared to chlorine. Ultraviolet (UV) irradiation has been developed as an alternative, non-chemical-based disinfection technology. Disadvantages of UV technology are the absence of disinfection residual beyond the treatment facility, the need for a clear optical pathway to enable UV ray penetration, and maintenance and replacement of lamps. In developing regions, chemical oxidant and UV disinfection techniques may be impractical. Additional disinfection techniques are needed.

### BRIEF SUMMARY

The present description provides microwave absorbing materials. The disclosed microwave absorbing materials are useful for generation of reactive oxygen species and disinfection of water upon exposure to microwave radiation.

In some embodiments, the microwave absorbing materials comprise a carbon nanomaterial and a plurality of metal oxide nanocrystals hybridized to the carbon nanomaterials. Although carbon nanomaterials may be useful for absorbing microwave radiation, modification of the electromagnetic properties of the carbon nanomaterial through hybridization improves the microwave absorbing abilities of the material. For example, hybridization of the metal oxide nanocrystals to the carbon nanomaterials may allow the material to absorb microwave radiation and generate reactive oxygen species and disinfect water.

For example, in some embodiments, a method of generating reactive oxygen species may comprise contacting a microwave absorbing material with water, such as a microwave absorbing material that comprises a carbon nanomaterial and a plurality of metal oxide nanocrystals hybridized to the carbon nanomaterials, and exposing the microwave absorbing material to microwave radiation, such that exposure of the microwave absorbing material to microwave radiation generates reactive oxygen species.

As another example, a method of disinfecting water may comprise contacting a microwave absorbing material with water containing a pathogen, such as a microwave absorbing material that comprises a carbon nanomaterial and a plurality of metal oxide nanocrystals hybridized to the carbon nanomaterials, and exposing the microwave absorbing material to microwave radiation, such that exposure of the microwave absorbing material to microwave radiation results in reduction of a concentration of the pathogen in the water.

In some embodiments, a microwave absorbing material can be prepared using a sol-gel process. For example, a microwave absorbing material may be made using a process comprising forming a suspension of a carbon nanomaterial in a solvent, adding a lanthanide series metal precursor solution to the suspension to form a mixture, removing solvent from the mixture to generate a residue comprising the carbon nanomaterial and lanthanide series metal, and calcining the residue to form a microwave absorbing material.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides a schematic illustration of a microwave absorbing material in accordance with some embodiments.

FIG. 2 provides a schematic overview of a method of making a microwave absorbing material in accordance with some embodiments.

FIG. 3 provides a schematic overview of generation of reactive oxygen species by exposing microwave absorbing material to microwave radiation, in accordance with some embodiments.

FIG. 4 provides a schematic overview of disinfection of water by exposing microwave absorbing material to microwave radiation, in accordance with some embodiments.

FIG. 5 provides representative HRTEM micrograph of (panel a) MWNT and (panel b) NH-1 (inset shows crystalline erbium oxide lattices); panel c shows a STEM image and elemental mapping of NH-1.

FIG. 6 provides (panel a) XPS spectra, (panel b) XPS region displaying typical Er4d multiplet structure, (panel c) XRD spectra of MWNT, erbium oxide, and NH-1, and (panel d) differential mass loss curve from TGA for the MWNT and NHs.

FIG. 7 provides (panel a) cell viability of Pseudomonas aeruginosa exposed to NH-1, and appropriate controls; (panel b) comparison of cell viability of P. aeruginosa exposed to NHs. Material concentration utilized in all experiments was maintained at 1 mg/L. Error bars represent one standard deviation measured from experimental triplicates.

FIG. 8 provides (panel a) H₂O₂ production with and without MW irradiation by NH-1 and by the appropriate controls; (panel b) comparison of ROS production between the NHs. Material concentration utilized in all experiments was maintained at 1 mg/L. Error bars represent one standard deviation measured from experimental triplicates.

FIG. 9 provides a schematic representation of the underlying mechanism for disinfection: (panel a) NHs suspended or attached to a relevant carrier in contact with water, (panel b) MW energy absorption by the NHs, (panel c) absorbed MW energy is transferred to neighboring nanocrystals resulting in charge separation and generation electron-hole pairs in the erbium oxide layer, and (panel d) donated ‘hot electrons’ produce ROS that inactivate bacteria.

FIG. 10 provides STEM HAADF images of a representative ion-beam irradiated samples of NH-1.

FIG. 11 provides STEM images and elemental mapping of the 3 synthesized NHs.

FIG. 12 provides data showing TGA analyses of representative functionalized MWNT and NH samples.

FIG. 13 provides data showing temperature differences between irradiated and microwave radiated samples. Differences are presented from room temperature (21° C.).

### DETAILED DESCRIPTION

### I. General

The present invention relates generally to microwave absorbing materials that may, for example, be used for the generation of reactive oxygen species and/or the disinfection of water. The microwave absorbing materials of some embodiments may include a carbon nanomaterial and a plurality of metal oxide nanocrystals associated with the carbon nanomaterial. For example, in some embodiments, the plurality of metal oxide nanocrystals may be in contact with the carbon nanomaterial. In some embodiments, the plurality of metal oxide nanocrystals may be hybridized with the carbon nanomaterial. Without wishing to be bound by any theory, in some embodiments, hybridization of the metal oxide nanocrystals to the carbon nanomaterial may advantageously provide the nanomaterial with the ability to absorb a plurality of microwave photons and use the combined absorbed photon energy to energize free electrons from the metal oxide nanocrystals that can then generate reactive oxygen species that may destroy pathogens.

In fact, the inventors have observed that exposing the microwave absorbing material to microwaves in the presence of water results in the generation of a significant concentration of reactive oxygen species in the water. For example, H₂O₂ species have surprisingly been observed by the inventors to be generated using the disclosed microwave absorbing material at two or more times the concentration as control samples, such as control samples including non-hybridized carbon nanomaterials.

Furthermore, the inventors have also observed that exposing the microwave absorbing material to microwaves for about 20 seconds in the presence of water containing pathogens results in an unexpected reduction of the concentration of the pathogens in the water. This observation is surprising because simply exposing the pure, unhybridized nanomaterial to microwaves for about 20 seconds in the presence of water does not result in the reduction of pathogen concentration, and, at best, simply results in heating the water, which may not be sufficient for destruction of many types of pathogens.

As an example, using a microwave power of 110 W for 20 s (an energy of only 0.0006 kWh), the inventors have observed a factor of 10 reduction in concentration of Pseudomonas aeruginosa in water. Disinfection techniques using ultraviolet (UV) or solar irradiated TiO₂ requires significantly higher time and/or energy requirements to achieve comparable inactivation amounts.

### II. Definitions

“Microwave radiation” and “microwaves” refers to electromagnetic radiation having a frequency in the range of about 300 MHz to about 300 GHz. Microwave radiation may be generated, for example, by a magnetron, such as may be included in a microwave oven. Microwave radiation may also be generated by a microwave frequency radio transmitter, such as may be included in some consumer electronics devices, such as cell phones and wireless network devices.

“Carbon nanomaterial” refers to a structure made from carbon and that is characterized by a dimension between 1 nm and 1000 nm. In some embodiments, carbon nanomaterials are characterized by dimensions between 1 nm and 100 nm. Example carbon nanomaterials include, but are not limited to, fullerenes, graphene, single-walled carbon nanotubes, multi-walled carbon nanotubes, nano-scale diamond crystals or nanodiamonds, and carbon nanofibers. In some embodiments, carbon nanomaterials may absorb microwave radiation. In some embodiments, carbon nanomaterials may include other chemical elements, such as hydrogen.

“Nanocrystal” refers to a structure made of atoms in a crystal arrangement and that is characterized by a dimension between 1 nm and 1000 nm. Example nanocrystals may be single crystal or polycrystalline. In some embodiments, nanocrystals may be characterized by dimensions between 1 nm and 100 nm.

“Lanthanide series metals” includes metallic elements having atomic numbers 57 through 71, and include lanthanum, cerium, praseodymium, neodymium, promethium, samarium, europium, gadolinium, terbium, dysprosium, holmium, erbium, thulium, ytterbium, and lutetium. In some embodiments, lanthanide series metals may form metal oxides, which may be referred to herein as “lanthanide series metal oxides.” In some embodiments, lanthanide series metal oxides may be used spectral conversion of lower-energy photons to higher-energy photons. In some embodiments, lanthanide series metal oxides may be used to release electrons in exterior electron shells upon energy absorption.

“Hybridized” refers to a type of chemical composition which includes one or more covalent bonds between chemical structures. In some embodiments, a metal oxide may be considered hybridized to a carbon compound when covalent bonds are formed between carbon atoms of the carbon compound and metal or oxygen atoms of the metal oxide.

“Sol-gel process” refers to a process in which a solution or suspension of materials in a solvent is formed and the solvent is removed, such as through a drying process, to gradually form a gel or network of solid materials. As the solvent is completely removed the residual solid material may compact, shrink, or otherwise densify, and may adopt a porous structure depending on the particular network of solid material formed. After drying, some sol-gel processes may include a sintering, calcining, or annealing phase in which the solid material is heated, with or without the presence of gas or oxygen. Sol-gel processes may be useful, in embodiments, for forming metal oxide nanocrystals.

“Reactive oxygen species” or “ROS” refers to chemically reactive molecules containing oxygen, and some related non-radical derivatives of O₂, such as H₂O₂, HOCl and O₃. The phrase “reactive oxygen species” is generally exclusive of ground state molecular oxygen (i.e., O₂, triplet oxygen, or ³O₂). Example reactive oxygen species include, but are not limited to, peroxides (e.g., hydrogen peroxide, H₂O₂), superoxide (i.e., O₂⁻ or O₂.⁻), hydroxyl radical (i.e., OH or OH.), and singlet oxygen (¹O₂). In embodiments, ROS may be generated through various processes, such as through the addition of electrons to oxygen molecules and/or water molecules and/or through addition of particular amounts of energy to oxygen molecules and/or water molecules.

“Pathogen” refers to a disease causing or infection causing agent, such as a virus, bacterium, or fungus. In some embodiments, pathogens may be transmissible via infected or contaminated fluids, such as water. In some embodiments, pathogens may be inactivated by exposure to ROS.

“Natural organic matter” and “NOM” refers to organic material present in surface or ground water, and may include dissolved and suspended organic materials. NOM may be characterized by a concentration in water, such as measured on a mass per volume basis.

“Hardness” refers to a measure of the mineral content in water and may specifically refer to a collective concentration of multivalent cations in water, such as Ca²⁺ and/or Mg²⁺. For example, in some embodiments, a hardness of 1 ppm refers to a concentration of Ca²⁺ when 1 mg of CaCO₃ is dissolved in 1 L of water.

“Disinfection” refers to a process of destroying pathogens, such as microorganisms and viruses. Disinfection may occur through an oxidation process in which pathogens are exposed to oxidizing agents, such as chlorine dioxide, ozone, or ROS. Disinfection may also occur, in some embodiments, by exposing the pathogen to electromagnetic radiation, such as UV electromagnetic radiation.

“Turbidity” refers to a relative clarity or transparency of a liquid, such as water, and may identify or relate to an amount of particulate matter suspended in the liquid. In some embodiments, turbidity may impact the ability of visible, UV, and/or infrared (IR) electromagnetic radiation to penetrate into the liquid. For example, the particles in water of high turbidity may decrease the ability of visible, UV, and/or IR electromagnetic radiation passing through or penetrating a significant depth or distance into the water. It will be appreciated that the turbidity of a liquid may be identified by a turbidity value, which may be expressed in terms of nephelometric turbidity units (NTU).

“Calcining” refers to a process in which a solid is exposed to heat with or without the presence of oxygen, such as to thermally decompose the solid or drive an oxidation of the solid. Example calcination conditions include exposing the solid to a temperature of about 400° C. or less in the presence of nitrogen (N₂). In some embodiments, calcination conditions may include temperatures elevated beyond ambient but less than a melting temperature of a particular metal that is being calcined. For example, in some embodiments, calcination conditions for materials including some lanthanide series metals may be selected from the range of 250° C. to about 1663° C. Calcination processes, in some embodiments, may be used to generate metal oxides from metal and oxygen or air.

“Sintering” refers to a process in which a solid is exposed to heat and/or pressure, such as to join or densify particles of the solid, to crystallize particles of the solid, or to alloy elements of the solid without melting the solid. Example sintering conditions include exposing the solid to a temperature of about 400° C. or less.

“Annealing” refers to a process in which a solid is exposed to heat in order to reduce or eliminate crystal defects in the solid without melting the solid. Example annealing conditions include exposing the solid to a temperature of about 400° C. or less. In some embodiments, annealing conditions may include temperatures elevated beyond ambient but less than a melting temperature of a particular metal that is being annealed. For example, in some embodiments, annealing conditions for materials including some lanthanide series metals may be selected from the range of 250° C. to about 1663° C.

A “suspension” refers to a heterogeneous mixture of a liquid, such as a solvent, and solid particles that are floating or otherwise held in the solvent without dissolving.

### III. Microwave Absorbing Materials

Microwave absorbing materials and methods of making and using Microwave absorbing materials are provided herein. In some embodiments, a microwave absorbing material comprises a carbon nanomaterial and a plurality of metal oxide nanocrystals associated with the carbon nanomaterial.

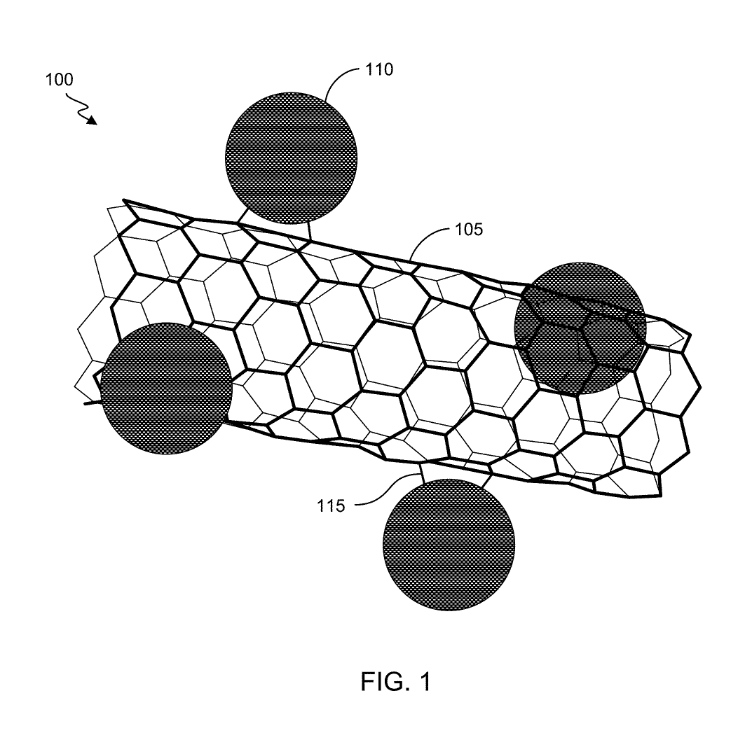

FIG. 1 provides a schematic illustration of a microwave absorbing material 100 in accordance with some embodiments. For example, microwave absorbing material 100 includes a carbon nanomaterial 105 and a plurality of metal oxide nanocrystals 110 associated with the carbon nanomaterial 105. As illustrated, the metal oxide nanocrystals 110 are hybridized with the carbon nanomaterial through one or more covalent bonds 115.

### A. Carbon Nanomaterials

A variety of carbon nanomaterials are useful with the microwave absorbing materials described herein. For example, the carbon nanomaterials may comprise multiwalled carbon nanotubes, single-walled carbon nanotubes, graphene, fullerenes, or nanodiamonds. In some embodiments, the carbon nanomaterial may be a microwave absorbing carbon nanomaterial. For example, the carbon nanomaterial may absorb microwave radiation, even when the carbon nanomaterial is not hybridized with the metal oxide nanocrystals.

In some embodiments, the carbon nanomaterials comprise multiwalled carbon nanotubes or single-walled carbon nanotubes. For example, in some embodiments, the carbon nanotubes may have diameters selected from the range of 5 nm to 50 nm, from the range of 8 nm to 40 nm, from the range of 10 nm to 30 nm, or from the range of 15 nm to 25 nm. In some embodiments, the carbon nanotubes have diameters selected from the range of 8 nm to 15 nm.

In some embodiments, the carbon nanomaterial is functionalized. For example, the carbon nanomaterials may be acid etched, such as by exposing the carbon nanomaterial to one or more of nitric acid or sulfuric acid. The carbon nanomaterial may, for example, also have additional functional groups attached to various carbon atoms in the carbon nanomaterial, such as hydroxyl groups, halogen atoms or halogen containing groups, and other organic groups or inorganic groups.

In some embodiments, metal oxide nanocrystals are hybridized with the carbon nanomaterials. For example, covalent bonds may be formed between the metal oxide nanocrystals and the carbon nanomaterial. In some embodiments, carbon-metal bonds hybridize the metal oxide nanocrystals with the carbon nanomaterials. In some embodiments, carbon-oxygen bonds hybridize the metal oxide nanocrystals with the carbon nanomaterials. In various embodiments, a molar ratio of metal oxide nanocrystals to carbon nanomaterials is selected from the range of about 1 to 1 to about 40 to 1. In some embodiments, carbon to metal molar ratios are about 16 to 1, 8 to 1, or 4 to 1. It will be appreciated that various molar ratios may be used.

### B. Metal Oxide Nanocrystals

The metal oxide nanocrystals hybridized with the carbon nanomaterial provide a number of specific advantages to the microwave absorbing materials disclosed herein. Without wishing to be bound by any theory, in some embodiments, the metal oxide nanocrystals may provide a microwave absorbing material with the ability to absorb microwave radiation and used the energy of multiple microwave photons in other processes, such as in the generation of ROS.

A variety of metal oxide nanocrystals are useful with the microwave absorbing materials described herein. For example, in some embodiments, the metal oxide nanocrystals comprise a lanthanide series metal. In some embodiments, the metal oxide nanocrystals comprise an oxide of a lanthanide series metal.

Optionally, the metal oxide nanocrystals comprise lanthanum, cerium, praseodymium, neodymium, promethium, samarium, europium, gadolinium, terbium, dysprosium, holmium, erbium, thulium, ytterbium, and/or lutetium. In a specific embodiment, the metal oxide nanocrystals comprise erbium.

Optionally, the metal oxide nanocrystals comprise lanthanum oxide, cerium oxide, praseodymium oxide, neodymium oxide, promethium oxide, samarium oxide, europium oxide, gadolinium oxide, terbium oxide, dysprosium oxide, holmium oxide, erbium oxide, thulium oxide, ytterbium oxide, and/or lutetium oxide. In a specific embodiment, the metal oxide nanocrystals comprise erbium oxide.

In some embodiments, the metal oxide nanocrystals may be single crystalline structures or may be polycrystalline structures. Optionally, the metal oxide nanocrystals have cross-sectional dimensions selected from the range of 10 nm to 1000 nm. In some embodiments, the metal oxide nanocrystals have dimensions selected from the range of 100 nm to 200 nm, 100 to 500 nm, 200 to 800 nm, 300 to 800 nm, or 400 to 600 nm. In some embodiments, the metal oxide nanocrystals may adopt any suitable shape, such as spherical or nearly spherical. The crystal structure of the metal oxide nanocrystals may dictate, in some embodiments, the shapes the nanocrystals may adopt. In some embodiments, the metal oxide nanocrystals are pure metal oxide structures. In some embodiments, the metal oxide nanocrystals are composite structures including a metal oxide crystal structure and other material.

### IV. Methods for Making Microwave Absorbing Material

Methods for making microwave absorbing materials are also provided, such as a microwave absorbing material comprising a carbon nanomaterial, and a plurality of metal oxide nanocrystals hybridized to the carbon nanomaterial. In some embodiments, a microwave absorbing material is formed using a sol-gel process.

In some embodiments, a method of making a microwave absorbing material comprises forming a suspension of a carbon nanomaterial in a solvent, adding a metal oxide precursor solution to the suspension to form a mixture, removing solvent from the mixture to generate a residue comprising the carbon nanomaterial and metal or metal oxide from the metal oxide precursor; and calcining the residue to form metal oxide nanocrystals and hybridize the metal oxide nanocrystals to the carbon nanomaterial, thereby forming the microwave absorbing material. In some embodiments, removing the solvent includes evaporating the solvent.

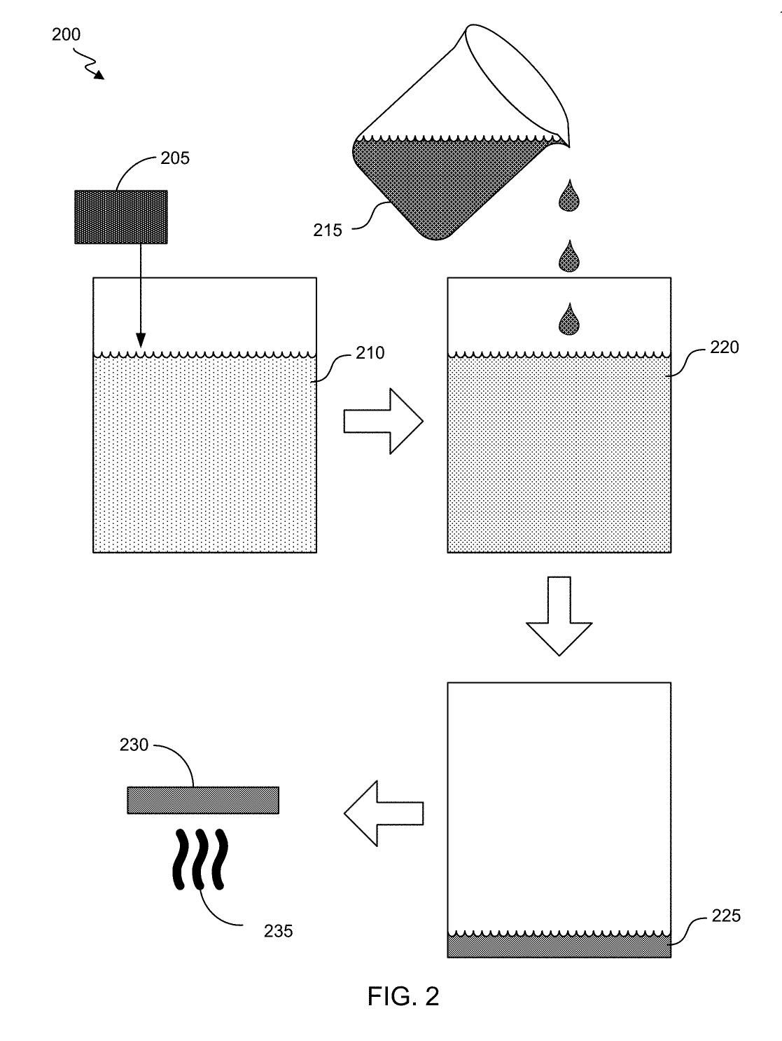

FIG. 2 provides a schematic overview of a method 200 of making a microwave absorbing material in accordance with some embodiments. Initially, a suspension of carbon nanomaterial 205 is formed in a solvent 210. Next, a metal oxide precursor solution 215 is added to the suspension to form mixture 220. Next, solvent from mixture 220 is removed, forming concentrated mixture 225 and ultimately a residue 230. Next, residue 230 is calcined, such as by exposing residue 230 to heat 235.

In some embodiments, the solvent is isopropanol. In some embodiments, forming the suspension comprises forming a cake of the carbon nanomaterial and grinding the cake to form a powder of the carbon nanomaterial. In some embodiments, forming the suspension comprises washing the carbon nanomaterial and drying the carbon nanomaterial. In some embodiments, the carbon nanomaterial is dispersed in the solvent with an ultrasonic dismembrator.

Various metal oxide precursors are useful with methods for making microwave absorbing materials. For example, in some embodiments, the metal oxide precursor solution comprises a metal nitrate salt or metal nitrate hydrate. In some embodiments, the metal oxide precursors comprises a lanthanide series metal nitrate or a lanthanide series metal nitrate hydrate. In some embodiments, the metal oxide precursor comprises Er(NO₃)₃.5H₂O dissolved in a solvent, such as isopropanol.

In some embodiments, adding the metal oxide precursor solution includes adding the metal oxide precursor solution drop-wise to the suspension. In some embodiments, the residue is calcined by exposing the residue to a temperature of about 400° C. Optionally, calcining includes heating the residue in a nitrogen atmosphere. Optionally, calcining includes heating the residue in an argon atmosphere. Optionally, calcining includes heating the residue in an oxygen containing atmosphere. Optionally, calcining includes heating the residue under vacuum.

It will be appreciated that any of the microwave absorbing materials described herein may be made using the methods described.

### V. Methods of Generating Reactive Oxygen Species

Methods of generating reactive oxygen species are also provided. In some embodiments, a method of producing reactive oxygen species comprises contacting a microwave absorbing material with water, such as a microwave absorbing material described herein (e.g., a microwave absorbing material comprising a carbon nanomaterial and a plurality of metal oxide nanocrystals associated with the carbon nanomaterial), and exposing the microwave absorbing material to microwave radiation, such that exposure of the microwave absorbing material to microwave radiation generates reactive oxygen species.

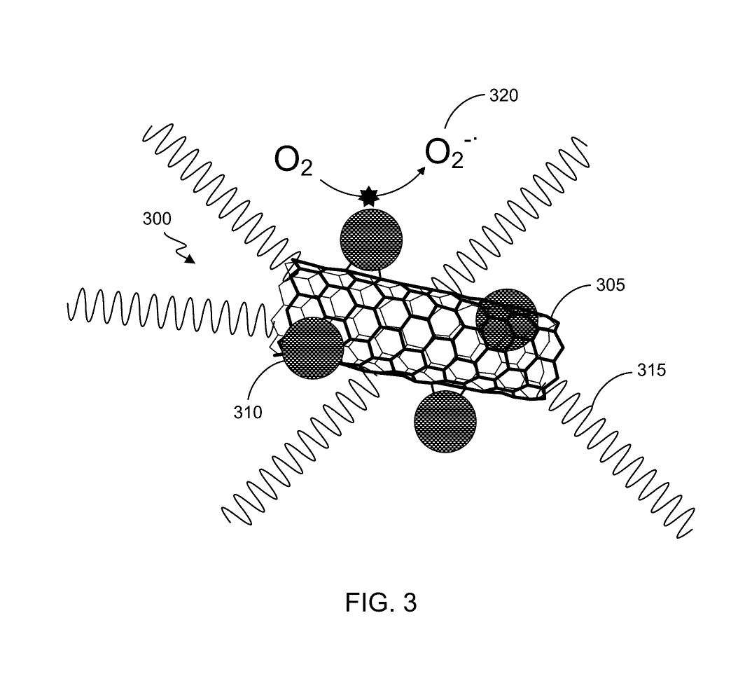

FIG. 3 provides a schematic overview of generation of reactive oxygen species by exposing microwave absorbing material 300 to microwave radiation 315, in accordance with some embodiments. Similar to the schematic illustration shown in FIG. 1, microwave absorbing material 300 includes carbon nanomaterial 305 and a plurality of metal oxide nanocrystals 310. Microwave radiation 315 is absorbed by the microwave absorbing material and the energy may be used to generate reactive oxygen species 320.

Without wishing to be bound by any theory, it is believed that exposure of the water and microwave absorbing material to microwave radiation generates reactive oxygen species, at least in part, through spectral conversion processes. For example, the carbon nanomaterial may absorb multiple photons of microwave radiation and used the combined energy of the multiple absorbed photons of microwave radiation in an energy promotion process that results in the generation of reactive oxygen species, such as an electron excitation process or a radical generation process.

Various microwave sources are useful with the methods of generating reactive oxygen species. For example, in some embodiments, the microwave radiation is generated by a magnetron source. In some embodiments, the microwave radiation is generated by a microwave oven, such as a commercial microwave oven useful for heating or reheating food.

Microwave radiation useful with the methods of generating reactive oxygen species may have frequencies selected from the range of 300 MHz to 300 GHz. In some embodiments, the microwave radiation has a frequency located in an ISM (industrial, scientific, medical) frequency band, which have been generally classified by various regulatory agencies as useful for unlicensed emission. In particular embodiments, the microwave radiation has a frequency of about 900 MHz or about 2.45 GHz. It will be appreciated that the microwave radiation of these frequencies find common usage in various application such as cellular and wireless communication and dielectric heating, such as using a microwave oven.

In some embodiments, low power exposure and/or short time exposure of the microwave absorbing material to microwave radiation is used for generating reactive oxygen species. In some embodiments, the power of the microwave source used for generating the microwave radiation is less than 1000 W, less than 500 W, less than 250 W, less than 150 W, less than 100 W, less than 50 W, or less than 25 W. In some embodiments, the duration of exposure to microwave radiation is less than 100 seconds, less than 1 minute, less than 50 seconds, less than 25 seconds, less than 10 seconds, or less than 5 seconds. It will be appreciated that the inventors have observed generation of significant amounts of reactive oxygen species using a microwave source power of 110 W for only 20 seconds, which may correspond to only 0.0006 kWh of energy used.

### VI. Methods of Disinfecting Water

Methods of disinfecting water are also provided. In some embodiments, a method of disinfecting water comprises contacting a microwave absorbing material with water containing a pathogen, such as a microwave absorbing material described herein (e.g., a microwave absorbing material comprising a carbon nanomaterial and a plurality of metal oxide nanocrystals associated with the carbon nanomaterial), and exposing the microwave absorbing material to microwave radiation, such that exposure of the microwave absorbing material to microwave radiation generates results in a reduction of the concentration of the pathogen in the water. For example, in some embodiments, exposure of the microwave absorbing material to microwave radiation results in reduction of the concentration of the pathogen in the water by a factor of 10 or more.

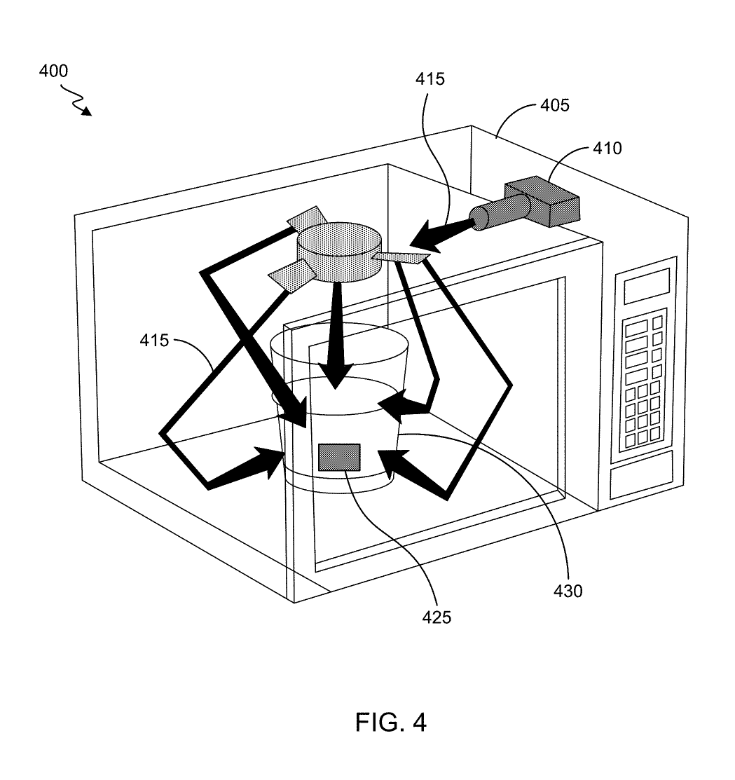

FIG. 4 provides a schematic overview 400 of disinfection of water by exposing microwave absorbing material to microwave radiation, in accordance with some embodiments. In this embodiment, a container of water 430 is placed inside microwave oven 405. A microwave source 410 of microwave oven 405 generates microwave radiation 415, which may be redirected, such as through one or more scattering and/or reflection processes, such that the microwave radiation is absorbed by the microwave absorbing material 425. In embodiments, various settings (e.g., power, time, etc.) for the microwave radiation may be adjusted using the control panel on the microwave oven 405, and the water may be disinfected.

Without wishing to be bound by any theory, it is believed that exposure of the water and microwave absorbing material to microwave radiation generates reactive oxygen species and the generated reactive oxygen species destroy or partly destroy pathogens in the water, such as by destruction or degradation of an enclosing structure, such as a cellular wall, protein coat, lipid envelope, etc., and/or by destruction or degradation of nucleic acids or other structures of the pathogen.

Various microwave sources are useful with the methods of disinfecting water. For example, in some embodiments, the microwave radiation is generated by a magnetron source. In some embodiments, the microwave radiation is generated by a microwave oven, such as a commercial microwave oven useful for heating or reheating food.

Microwave radiation useful with the methods of purifying water may have frequencies selected from the range of 300 MHz to 300 GHz. In some embodiments, the microwave radiation has a frequency located in an ISM (industrial, scientific, medical) frequency band, which have been generally classified by various regulatory agencies as useful for unlicensed emission. In particular embodiments, the microwave radiation has a frequency of about 900 MHz or about 2.45 GHz. It will be appreciated that the microwave radiation of these frequencies find common usage in various application such as cellular and wireless communication and dielectric heating, such as using a microwave oven.

In some embodiments, low power exposure and/or short time exposure of the microwave absorbing material to microwave radiation is used for disinfecting water. In some embodiments, the power of the microwave source used for generating the microwave radiation is less than 1000 W, less than 500 W, less than 250 W, less than 150 W, less than 100 W, less than 50 W, or less than 25 W. In some embodiments, the duration of exposure to microwave radiation is less than 100 seconds, less than 50 seconds, less than 25 seconds, less than 10 seconds, or less than 5 seconds. It will be appreciated that the inventors have observed reduction of a pathogen concentration by a factor of 10 using a microwave source power of 110 W for only 20 seconds, which may correspond to only 0.0006 kWh of energy used.

It will be appreciated that, unlike UV sterilization, the disclosed methods of disinfecting water are useful in systems that do not possess optical transparency. As compared to UV radiation, where a transparent optical path is required for penetration of the radiation into the water, microwave radiation, due to its relative shortwave nature, may penetrate through opaque structures and systems and reach the microwave absorbing material for generation of reactive oxygen species and/or disinfection of water. For example, the water may be held inside an optical or UV opaque container, which would shade or otherwise prevent UV radiation from reaching inside. In some embodiments, the water may be turbid or have low optical transparency.

For example, in some embodiments, the disclosed methods of disinfecting water are useful with water that has turbidity greater than 50 NTU (Nephelometric Turbidity Units), greater than 100 NTU, greater than 250 NTU, or greater than 500 NTU. In some embodiments, the disclosed methods of disinfecting water are useful with water that has a concentration of organic matter, such as natural organic matter, dissolved organic matter, and/or suspended organic matter, greater than greater than 5 mg/L, greater than 10 mg/L, greater than 25 mg/L or greater than 50 mg/L. In some embodiments, the disclosed methods of disinfecting water are useful with water that has hardness greater than 60 ppm, greater than 120 ppm, or greater than 180 ppm. It will be appreciated that hard water, turbid water, and/or water with high concentrations of organic matter may be ineffectively or inefficiently disinfected by other purification methods, such as exposure to UV radiation.

### VII. Examples

The invention may be further understood by reference to the following non-limiting example.

### Example 1: Harnessing the Power of Microwave for Disinfection with Nanohybrids

Due to the position of microwave radiation in the electromagnetic spectrum, it has not been successfully utilized to disinfect water, to-date. Exceptional properties at the nano-scale, namely microwave absorption-abilities of carbon nanotubes and excellent spectral conversion-capabilities of lanthanide series metal oxides in concert, hold promise to overcome the energetic barrier of this widely used and affordable technology. This example reports synthesis of a nano-heterostructure that combines carbon nanotubes' and erbium oxides' properties to generate reactive oxygen species and inactivate Pseudomonas aeruginosa. Detailed characterization of the synthesized materials with electron microscopy, X-ray techniques, and thermal gravimetric analysis confirms effective hybridization. At least one log unit of microbial inactivation was achieved via reactive oxygen species generation with only 20 s of microwave irradiation at 110 W (0.0006 kW·h energy use). These breakthrough results hold promise to enable an unintended use (of disinfection) of microwave technology, which is diffused deep into the global societal fabric.

The Schumpeterian trilogy of technological change, i.e., invention, innovation, and diffusion, highlights the importance and benefits of societal acceptance of any new technology. Once a technology has diffused deep into the societal fabric, the spectrum of its application expands and allows for unintended uses, some of which might be transformative. One such example is mobile communication, which was not originally engineered to assist in healthcare, but now is utilized to disseminate healthcare information and has transformed this sector globally. Microwave (MW) technology is affordable and similar in social adoptability and thus, by way of the present invention, can be utilized to impact low-income communities across the globe, particularly to gain them access to safe drinking water. Although the position of MW radiation in the electromagnetic spectrum precludes the use of MW to disinfect water at a reasonable cost, finding a way to harness the power of MW radiation in an effective disinfection technology could potentially benefit a large global population.

Ensuring water safety via disinfection has largely relied on the use of chemical oxidants since early 1900s. Common use of such chemicals include chlorine, chlorine dioxide, and ozone. Ammonia added simultaneously or consecutively with chlorine forms another common disinfectant, chloramines, which is a less effective, but more persistent as compared to chlorine. However, chemical disinfectants lead to the production of disinfection by-products (DBPs), which have raised public health concerns since the early 1970s. Alternative non-chemical based disinfection technologies became necessary, and ultraviolet (UV) irradiation has been developed as an effective disinfection alternative. UV's germicidal effect is a result of the UV action on the nucleic acids of microorganisms and its efficacy depends on light intensity and exposure time. Disadvantages of UV technology are the absence of disinfection residual beyond treatment facility, its need for a clear optical pathway to enable UV rays penetration, and maintenance to prevent fouling of lamps. Furthermore, UV technology is not commonly available at every household, rather it needs to be custom-made with the purpose of disinfecting water.

Irradiation-based disinfection technologies are gaining popularity because of advances in equipment reliability and reduction of undesirable disinfection by-products. The rapid growth of nanotechnology has prompted significant interest in environmental applications and nano-scale materials are now being incorporated into such irradiation-based disinfection devices to improve reliability, reduce operating costs, and increase their disinfection efficiency. Nanoparticles are used as photocatalysts to enhance and accelerate the inactivation rate of pathogenic microorganisms. Light irradiated onto photocatalytic materials can effectively generate reactive oxygen species (ROS), one of the key modes of disinfection. Of particular interest are combinations of materials and irradiation systems that use low-cost visible and/or UV light to achieve high disinfection throughput. However, efficiency of any such technology depends on incident flux and wavelength of the radiation, specific water characteristics, absorption length in water, geometry and reactor hydrodynamics, contact efficiency of species in water and the photocatalysts, and inactivation kinetics.

A growing interest in enhancing low-energy electromagnetic radiation, e.g., visible and near infrared radiation, has been successfully shown to produce ROS as a part of the continuous effort to develop new alternative disinfection technologies. Such amplification of low energy photons to higher energy has been successfully demonstrated using lanthanide series metals (e.g., Er³⁺ and Tm³⁺). Their unique 4fⁿ (n=0-14) 5d⁰⁻¹ inner shell configurations are well shielded by the outer filled 5s²5p⁶ sub-shell electrons and thus have abundance of unique energy levels. When populated, these states can be long lived (up to 0.1 s), making these ideal to serve as electron donators. This group of trivalent metals is also doped to engineer the band architecture and utilized in different applications. To-date, successful utilization of low energy MW radiation for efficient generation of ROS and thus disinfection has not been demonstrated. However, there is promise in carbon nanomaterials' ability to absorb MW energy and lanthanide series metal's capacity to enhance spectral-conversion, if used in concert.

Developed during the Second World War, low-frequency MWs (at least 5 orders of magnitude lower than UV) have disseminated into industry and later into the household consumption market in a short period of time. MWs lie between infrared radiation and radio frequencies and correspond to wavelengths of 10⁻³ to 1 m (300 GHz to 300 MHz frequencies, respectively). In this region, the energy of the MW photon (between 1.24×10⁻³ to 1.24×10⁻⁶ eV) is too weak to break chemical bonds, when compared to that of photons emitted by UV lamps with wavelengths ranging between 200 to 280 nm (6.20 to 4.43 eV). However, even this apparently weak MW radiation has proven to be germicidal when used at high intensity and for an extended period of time, when sterilizing dry materials. MW technology is effectively used to disinfect dentures and dental tools/devices, where 10 min of microwaving at 720 W is required for sterilization. The antimicrobial impact of MW radiation is not well understood, but it is hypothesized to emanate mostly from thermal action and also from dielectric rupture. However, disinfecting water with MW has not been successful to-date, likely due to extended irradiation period and associated energy costs.

An alternative irradiation-based disinfection technology that can take advantage of an already adopted, affordable, and available device, while overcoming most of the limitations of available disinfection processes, can be greatly beneficial. In this example, the MW absorption-potential of carbon nanotubes with the known spectral conversion-ability of lanthanide series metal oxides have been combined and its water disinfection potency is demonstrated. A novel nanohybrid (NH), multiwalled carbon nanotube (MWNT) chemically conjugated with erbium (Er³⁺) oxide, has been synthesized using a sol gel method. The material has been characterized to confirm hybridization and determine its physicochemical properties via high-resolution transmission electron microscopy (HRTEM), scanning transmission electron microscopy (STEM), thermal gravimetric analysis (TGA), X-ray diffraction (XRD), and X-ray photoelectron spectroscopy (XPS). This example presents breakthrough inactivation results of a common model opportunistic pathogen, P. aeruginosa. Mechanism of disinfection has been enumerated by determining ROS generation. Results obtained from this example can be considered as the ‘invention’ of a new water irradiation-based disinfection technology that enables an unintended use of disinfection for widely available MW technology, which can potentially give a large global population access to safe drinking water.

### Experimental

Materials. Isopropanol (2-propanol, 99%, USP), nitric acid (70%), and concentrated sulfuric acid were obtained from Fisher Scientific (Houston, Tex.). MWNTs (>95% carbon purity) with an average diameter of 8-15 nm and length of 10-50 μm were obtained from Cheap Tubes Inc., (Cambridgeport, Vt.). Amplex® UltraRed reagent (Cat. No. A36006) and Amplex® Red/UltraRed stop reagent (Cat. No. A33855) were procured from Invitrogen (Carlsbad, Calif.). Erbium(III) oxide (99.5%, REO) was purchased from Alfa Aesar™ (Ward Hill, Mass.) while erbium(III) nitrate pentahydrate (99.9% trace metal basis) was procured from Acros Organics™ (Geel, Belgium). Other reagents were purchased from Fisher Scientific (Houston, Tex.), unless otherwise noted.

Synthesis of NHs.

MWNTs with an average diameter of 8-15 nm and >95% purity (Cheap Tubes Inc., Cambridgeport, Vt.) were first acid-etched by refluxing in a 1:1 (v/v) mixture of concentrated nitric (70%) and sulfuric acid (96.5%) at 80° C. for 3 h. Functionalized MWNTs were thoroughly washed with ultrapure water (Synergy ultrapure water, EMD Millipore, Darmstadt, Germany) and vacuum-filtered using porous polytetrafluoroethylene (PTFE) membrane filters (0.2 μM, EMD Millipore, Darmstadt, Germany). The MWNT cake obtained was washed with distilled water until the pH was neutral, dried in a desiccator, and subsequently hand-grinded with mortar and pestle to fine powder to be dispersed in anhydrous isopropanol with an ultrasonic dismembrator (Q700 Qsonica, Newtown, Conn.). NHs with three C:Er molar ratios, NH-1 (16:1), NH-2 (8:1), and NH-3 (4:1), were synthesized (Table 1) via a sol gel process. For this purpose, erbium precursor (Er(NO₃)₃.5H₂O) was dissolved in isopropanol (Table 1), bath sonicated, and added drop-wise at a constant rate (0.435 mL/min) to the previously dispersed MWNTs under ultra-high purity N₂ (NI UHP15A, Airgas) at 80° C. for 3 h. The mixture was then evaporated and the residue was calcined under N₂ at 400° C. for 3 h in a tube furnace (Lindberg/Blue M TF55035A-1, Thermo Scientific, Asheville, N.C.). Finally, the NHs were hand-grinded with mortar and pestle and dispersed ultrasonically in ultrapure water before use. All chemicals and materials used were purchased from Fisher Scientific (Houston, Tex.) unless otherwise noted.

NHs Characterization.

A JEOL 2010F HRTEM (JEOL USA Inc., Pleasanton, Calif.) at various magnifications and at an accelerating voltage of 200 kV collected MWNT and NH images. The same equipment was used to obtain high annular angle dark field STEM images at high magnification alongside with EDX to obtain elemental mapping of the materials. Crystalline structures of the powdered samples were investigated by performing XRD using a Rigaku R-axis Spider (Rigaku Americas Corporation, The Woodlands, Tex.). The XRD has a curved imaged plate diffractometer equipped with an image plate detector and Cu-Kα irradiator (0.154 nm wavelength) and a graphite monochromator. Thermal oxidation properties were examined using a TGA with differential scanning calorimetric capabilities (Mettler-Toledo AG, Schwerzenbach, Switzerland). TGA was performed by flowing air between 25 and 800° C. with a heating ramp of 10° C. min⁻¹. XPS (Kratos Axis Ultra DLD, Kratos Analytical Ltd., Manchester, UK) spectra were recorded on dry powders to examine the surface chemistry of the samples.

Disinfection Potency.

Antimicrobiality was assessed by exposing a gram-negative opportunistic pathogenic strain of P. aeruginosa PAO1 to the NHs with appropriate controls. A freezer stock of PAO1 was streaked on a Luria Bertani (LB) agar plate and grown overnight. A single colony from the plate was inoculated in 15 mL LB medium and incubated at 37° C. at a shaker (200 rpm) for 16 h. 100 μL of the culture was added to a fresh LB medium and was incubated at 37° C. for 4-6 h until the culture reached mid-exponential phase (optical density at 600 nm of 0.25-0.30). The suspension was then centrifuged (5810R, Eppendorf AG, Hamburg, Germany) at 2500×g for 15 min, and the supernatant was removed. The remaining cell residue was re-suspended in 15 mL 1× Gibco™ phosphate buffer saline (PBS) solution (Fisher Scientific, Pittsburgh, Pa.). This procedure of centrifugation and re-suspension in PBS media was repeated twice to remove the remaining LB growth medium. Concentrations of 10 mg/L erbium salts, erbium oxide, MWNTs, and NHs samples were prepared in 1×PBS as stocks. Each sample was autoclaved and bath sonicated for 30 min prior to the exposure studies. A 20 μL sample was then added to 180 μL of the bacterial suspension (in PBS) on a microtiter plate to achieve a final bacterial exposure concentration of 1 mg/L for each sample. A control was also prepared by adding 20 μL sterile ultrapure DI water to the bacterial suspension to account for the same dilution as that of the other samples. Bacterial suspensions were then subjected to MW irradiation (20 s at 110 W), while an identical set of samples was kept in the dark for the same exposure time. Each sample was tested in triplicates. The samples were then serially diluted using 1×PBS, 10 μL samples were pipetted and grown on LB agar plates, incubated for 12-16 h at 37° C., and finally colonies were enumerated by direct count.

Disinfection Mechanism Determination.

During nanomaterial exposure, bacteria can experience stress from a selected set of stressors, among which dissolved metal ions and ROS are most common. Bacteria can also be stressed via heat shock and other external reactive stressors, e.g., hydrogen peroxide. To identify the dominant underlying mechanism for disinfection, following protocols are established.

Measuring Temperature Change.

The temperature of the samples was measured by a k-type beaded wire stainless steel thermocouple (SC-GG-K-30-36, Omega, Stamford, Conn.) before and after MW irradiation. The thermocouple was connected to a digital thermometer (CL3512A, Omega, Stamford, Conn.), with a temperature range of −220 to 1372° C. It is acknowledged that such measurements will produce bulk change in temperature and will be incapable of determining local variation at the nano-scale.

Determination of H₂O₂ Concentration.

A non-radical derivative of oxygen as a surrogate for ROS, H₂O₂, was monitored with Amplex® UltraRed Reagent (Cat. No. A36006) hydrogen peroxide/peroxidase assay kit with Amplex® Red/UltraRed Stop Reagent (Cat. No. A33855). This compound is non-fluorescent until it is reacted with a combination of H₂O₂ and horseradish peroxidase. Samples of erbium salt, erbium oxide, MWNTs and NHs were individually dispersed in ultrapure DI water at 1 mg/L. The prepared samples and nanomaterial suspensions were added to the working solution of the ROS assay kit using a 96-well black assay microplate (Corning, N.Y.), following the manufacturer's protocol. To evaluate the MW-induced H₂O₂ generation, the suspended samples were irradiated for 20 s at 110 W (611 mW·h) with a conventional MW oven (1100 W, 2.4 GHz, JES1460DSBB, GE®). An identical set of samples was kept in the dark for the same time of exposure. Amplex Ultrared stop reagent was added to each sample to capture the fluorescence of the oxidized product until measured using a Synergy-HT microplate reader (Biotek, Winooski, Vt.) with appropriate excitation (485 nm) and emission filters (590 nm). Each measurement was performed in triplicates and the background fluorescence intensity (for DI water) was subtracted from all readings.

Results and Discussion.

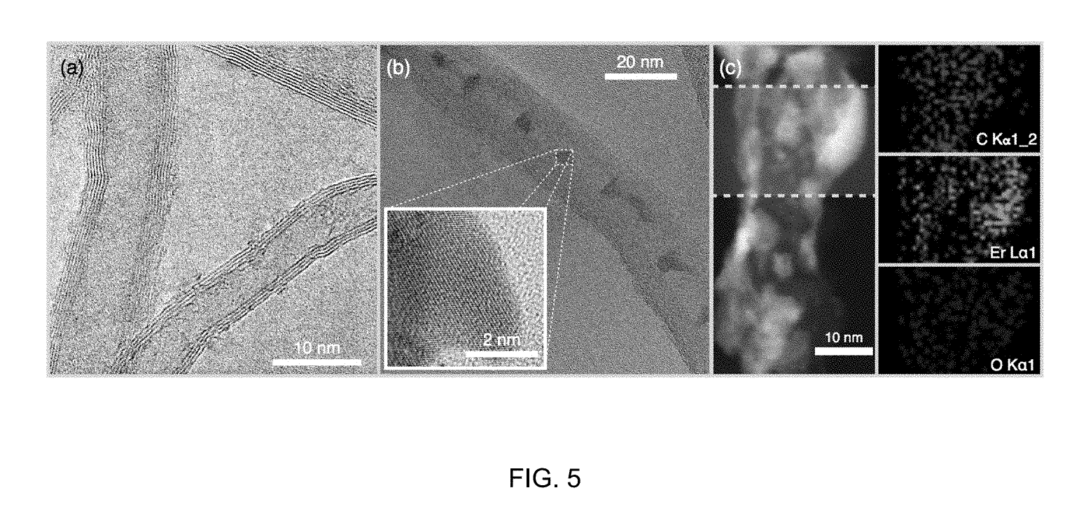

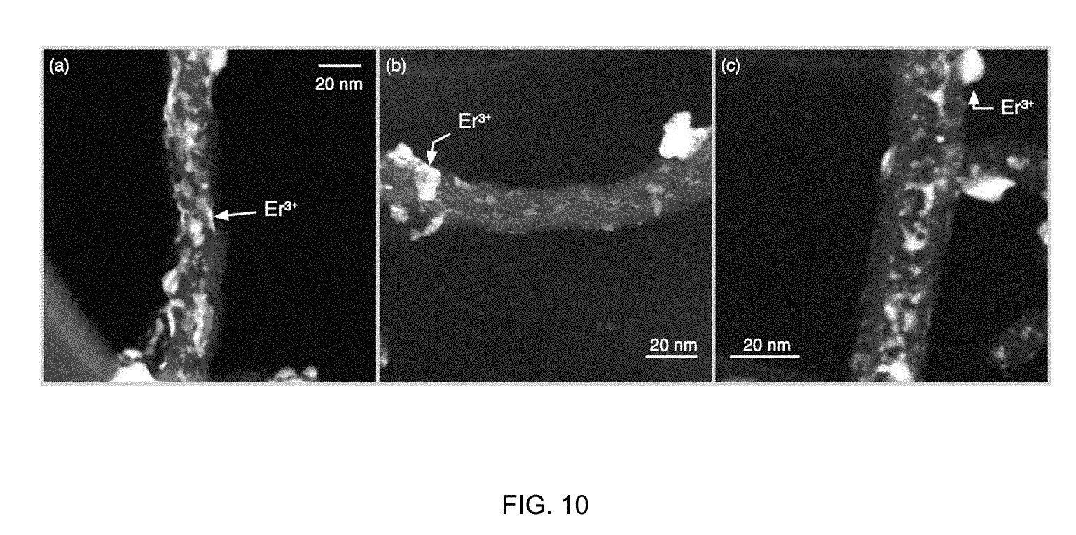

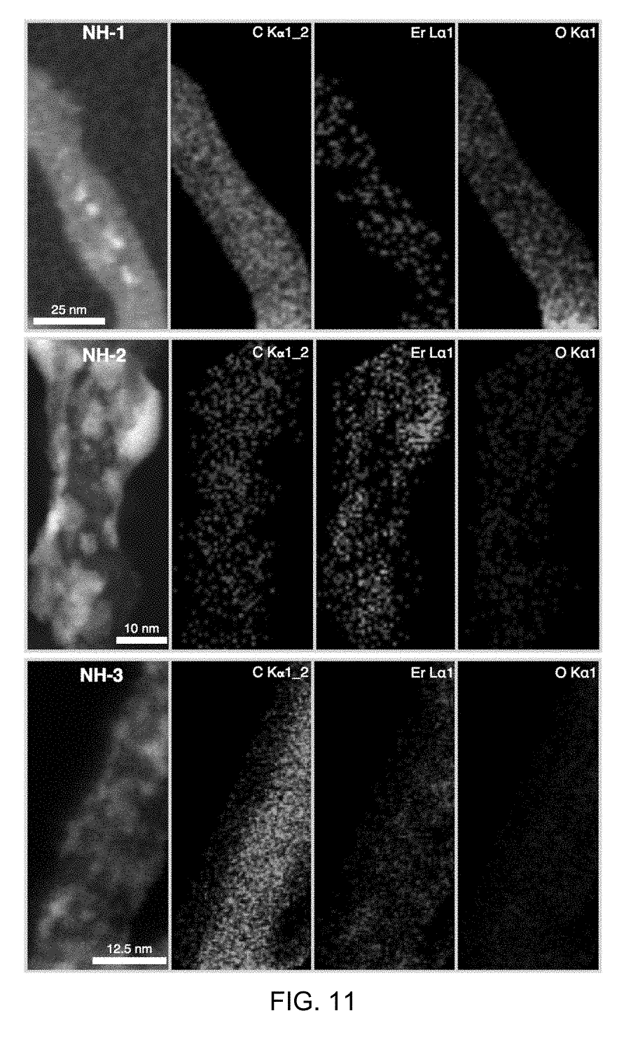

Synthesis and Characterization of the NHs. NHs with three C:Er³⁺ molar ratios, i.e., 16:1 (NH-1), 8:1 (NH-2), and 4:1 (NH-3), are synthesized (Table 1) via a sol gel process. Representative HRTEMs and STEM micrographs show successful hybridization of MWNTs with Er (FIG. 5 and FIG. 10). The HRTEM micrograph displays debundled MWNTs with average shell thickness of 21.3±2.6 nm (FIG. 5, panel a), where crystalline features are uniformly distributed at the surfaces of the MWNTs indicating hybridization with a metal/metal oxide nanocrystal (FIG. 5, panel b and FIG. 10). The elemental composition of the hybridized MWNTs and the uniformity of the metal oxide nanocrystals are presented via STEM imaging (FIG. 5, panel c). Representative STEM element-specific micrographs show uniform distribution for C, Er, and O, throughout the MWNT backbone. Control over synthesis with loading and distribution uniformity of erbium oxide on MWNTs is demonstrated via STEM images, elemental mapping, and elemental composition (Table 2 and FIG. 11).

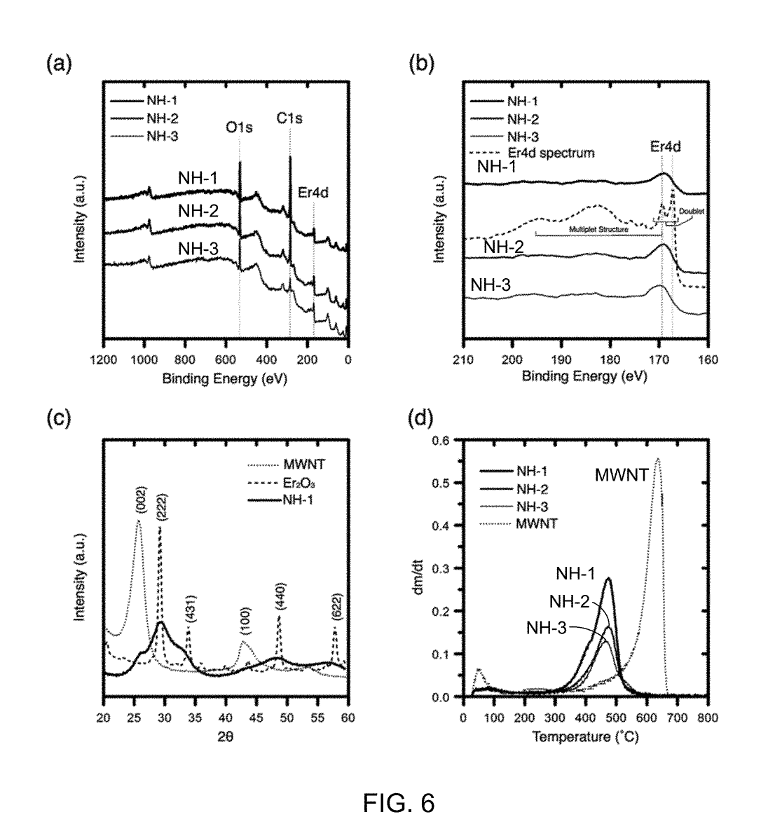

Quantitation of elemental composition for the NHs is presented with XPS analysis (FIG. 6, panel a). XPS spectra for the NHs with varied Er loading reveal the presence of characteristic O1s, C1s, and Er4d peaks (FIG. 6, panel a). O1s peaks (at 532 eV) are narrow and confirm the presence of different forms of metal oxides and C—O bonds on the surface of the MWNTs. C1s (at 284.8 eV) peaks are typical for sp³ hybridized C—C bonds. The region of Er4d does not exhibit a typical free ion doublet structure at the region between binding energies of 167.5 and 169.5 eV, and the complex multiplet structure to the left of the peak at 169.5 eV is attenuated as shown by the 3 NH signals (FIG. 6, panel b). However, the peaks at binding energy 169 eV are typical of Er₂O₃ compound, which will change the spacing and intensity of the doublet peaks after an annealing process. The atomic ratios of C:Er³⁺ obtained (Table 3) via XPS are 1.29 (NH-1), 0.72 (NH-2), and 0.19 (NH-3), which demonstrate achieving control over the hybridization process.

The crystallinity of erbium oxides on MWNT surfaces is confirmed with XRD spectra (FIG. 6, panel c). MWNT XRD spectrum (gray) shows a distinctive sharp peak and small broad peaks at 26.3° and 43°, which correspond to (002) and (100) lattice planes, respectively. The XRD spectrum of erbium oxide (dash blue) shows highly crystalline Er₂O₃ signature with a sharp peak at 29.4°, which corresponds to (222) diffraction planes. Other diffraction planes analyzed, i.e., (211), (431), (440), and (622), are consistent with related observations. The XRD spectrum of the representative NH-1 shows suppressed peak occurrences for those of the MWNTs, suggesting successful hybridization of the material.

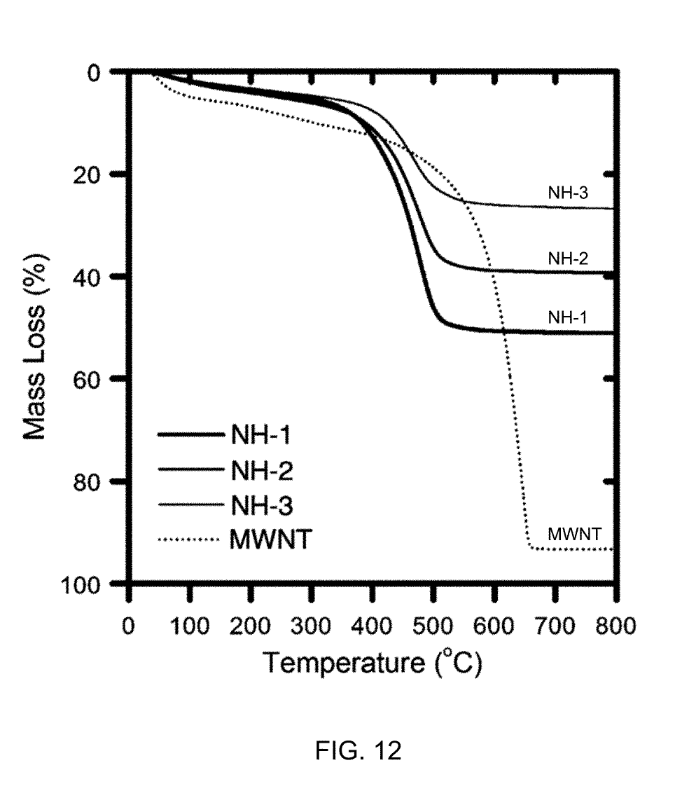

To determine whether the erbium oxide nanocrystals crystallized onto MWNT surfaces with no chemical bonding or rather true hybridization has been achieved, peak oxidation temperature of the MWNTs and NHs is determined. TGA results (FIG. 6, panel d) show a significant downward shift of the peak oxidation temperature (from 636° C. to 475° C.) for MWNTs upon hybridization. Such shift can be attributed to enhanced heat flow onto MWNT surfaces via chemically bonded metallic nanocrystals. The downward shift in the peak temperature persisted with the increase in erbium oxide content, which further supports the heat flow analysis. Analyzing the % mass loss profiles of these materials (FIG. 12) reveals mass remaining percentages of unhybridized and hybridized MWNTs, i.e., 6.8% (MWNT), 48.1% (NH-1), 60.7% (NH-2), and 73.2% (NH-3), which concur well with the metal content analysis obtained from EDX (Table 2).

Disinfection Potency.

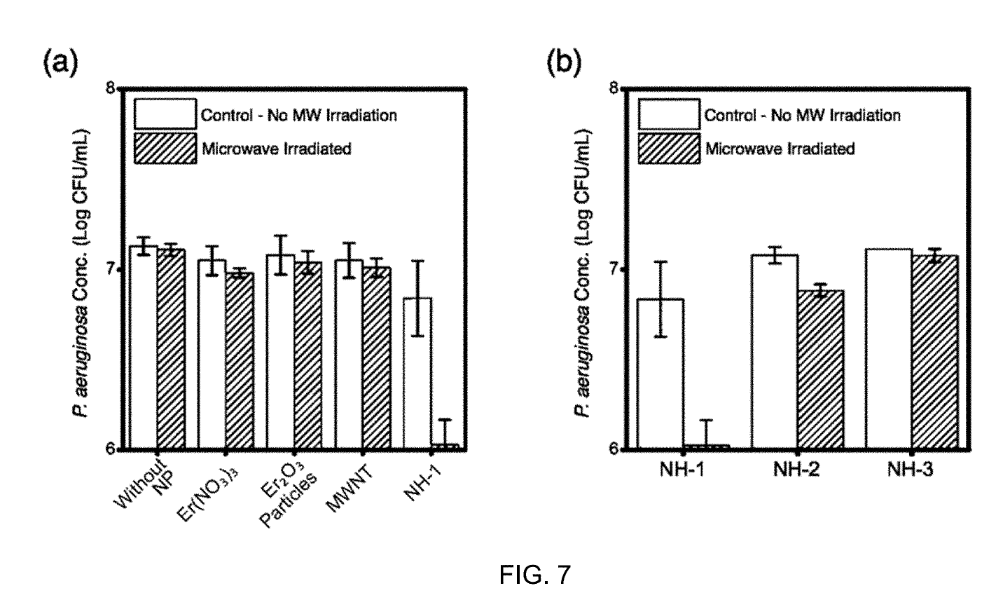

Inactivation of opportunistic pathogen P. aeruginosa with an initial population density of ˜10⁷ CFU/mL is successfully achieved with MW irradiation in presence of NHs (FIG. 7). The control samples (irradiated and non-irradiated Er salt, Er oxide particles, and MWNTs) show no significant impact on bacterial inactivation (FIG. 7, panel a). NH-1 shows at least one log unit reduction of P. aeruginosa when compared to appropriate unirradiated controls and other irradiated materials. Inactivation of P. aeruginosa with other samples is not observed. The increase in Er oxide loading onto MWNTs (irradiated samples) shows a negative correlation with bacterial viability reduction (FIG. 7, panel b).

Microwave's potency of inactivating P. aeruginosa compares well with literature reports; however, these nanomaterials allow achieving such disinfection efficiency at a much lower irradiation time (20 s) and energy cost (0.0006 kW·h). Literature evidences suggest that strains of P. aeruginosa (AOH1 and NCIMB 10421) when exposed to photocatalytic Ag—TiO₂ films and irradiated with UV for at least 1-6 h, can result in one log bacterial reduction (energy expenditure: 2.24 mW·cm⁻²). Similarly single log inactivation of P. aeruginosa (NCTC 10662) was also achieved by photocatalytic TiO₂ thin film treatment, when irradiated with UV (3 mW·cm⁻²) for 35 min. Comparable inactivation efficiency of P. aeruginosa (ATCC 9027) is observed for solar irradiated TiO₂ when irradiated for 1 h (energy expenditure: 1 kW·h). Escherichia coli (OH157:H7), a more susceptible bacterial species to irradiative inactivation (compared to P. aeruginosa), underwent single log inactivation with C₇₀-modified TiO₂ NHs under 10 min irradiation of visible light (energy expenditure: 0.05 kW·h). The results presented herein demonstrate superior inactivation performance of the novel NHs prepared in this example, where an opportunistic pathogenic strain is irradiated with the lowest intensity electromagnetic radiation, MWs. In this example, a significant reduction in exposure time and expended energy compared to literature reported UV and visible radiation excited nanomaterial inactivation cases, further proves the efficacy and transformative nature of this nano-enabled disinfection technology.

Proposed Disinfection Mechanisms.

Dissolution of metal ions. Literature suggests that dissolution of metal ions from high curvature nano-sized particles can serve as a dominant mechanism for disinfection; e.g., nano-Ag, which contributes ionic silver, is utilized as an effective disinfectant. The NHs utilized in this example however, contain a lanthanide series metal oxide (i.e., erbium), which has extremely low aqueous solubility, thus likely will not incur antimicrobiality via dissolution. Results presented in FIG. 7, panel a, further validates this claim. P. aeruginosa when exposed to dissolved Er³⁺ in an amount equivalent to Er present in the NHs show no appreciable inactivation. Thus dissolved ions is not likely the cause of bacterial inactivation in this case.

Microwave Heating.

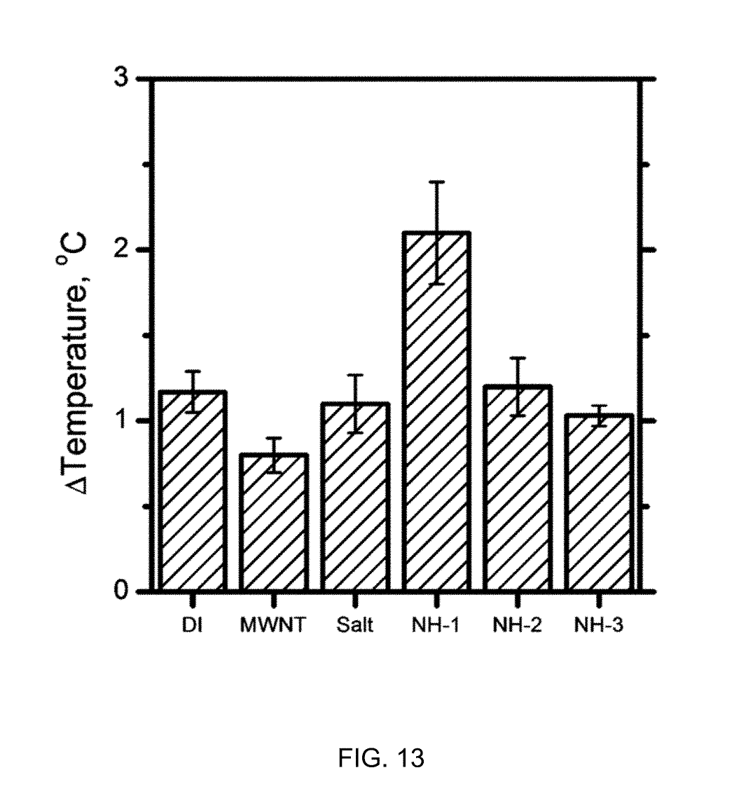

An increase of temperature over time can result in denaturation, damage to the cell membrane, and coagulation of protein materials inside the bacterial cells, affecting their viability. Studies have shown that viable counts of high bacterial density cultures of P. aeruginosa (1.7×10⁹ CFU cm⁻²) decrease up to 6 orders of magnitude when subjected to 50-80° C. for 1-30 min. However, the maximum temperature change recorded in this example is 2.10±0.30° C. from room temperature, when the samples were MW-irradiated for 20 s at 110 W (Table 4 and FIG. 13). Such evidences suggest that inactivation by thermal shock of P. aeruginosa or MW heating is unlikely to be the dominant mechanism for inactivation for this example.

Synergistic Effects of combined MW heating and ROS species. Antimicrobial action via MW heating can be significantly enhanced if complemented with low concentration of H₂O₂. Both cell destruction and DNA injuries can be been achieved as shown for exposure of E. coli (K-12) and P. aeruginosa (102) to consecutive MW irradiation (up to 50° C.) and addition of H₂O₂ (0.08% v/v). It is believed that the synergistic effects consist of inhibition of the repair mechanisms in bacteria due to ROS addition. However, in this example, no additional H₂O₂ was added to the system. The range of temperature increase (˜2° C.) and no H₂O₂ addition thus remove this mechanism as a possible route for disinfection in this example.

ROS-Mediated Antimicrobiality.

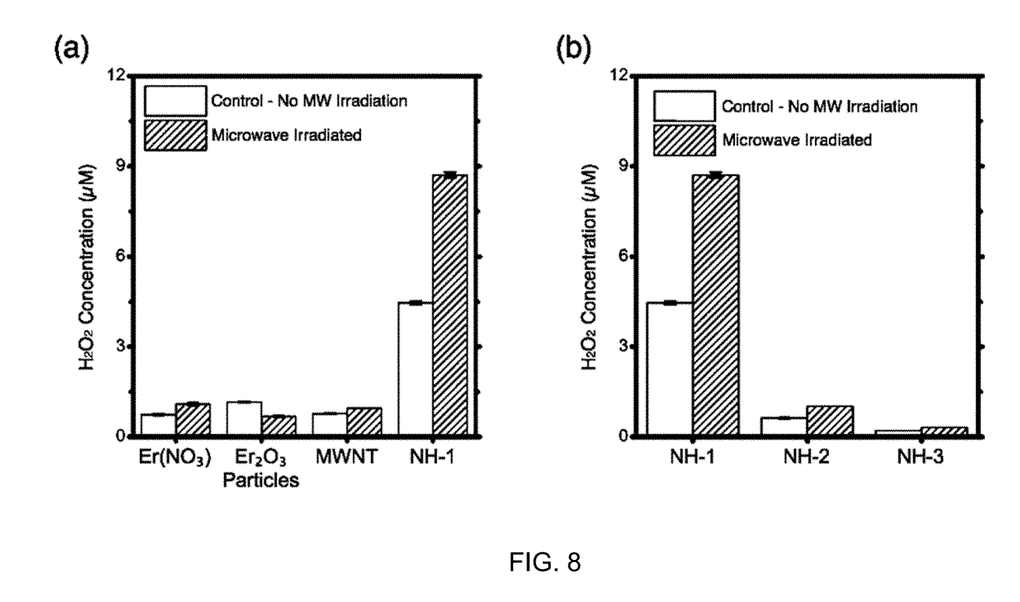

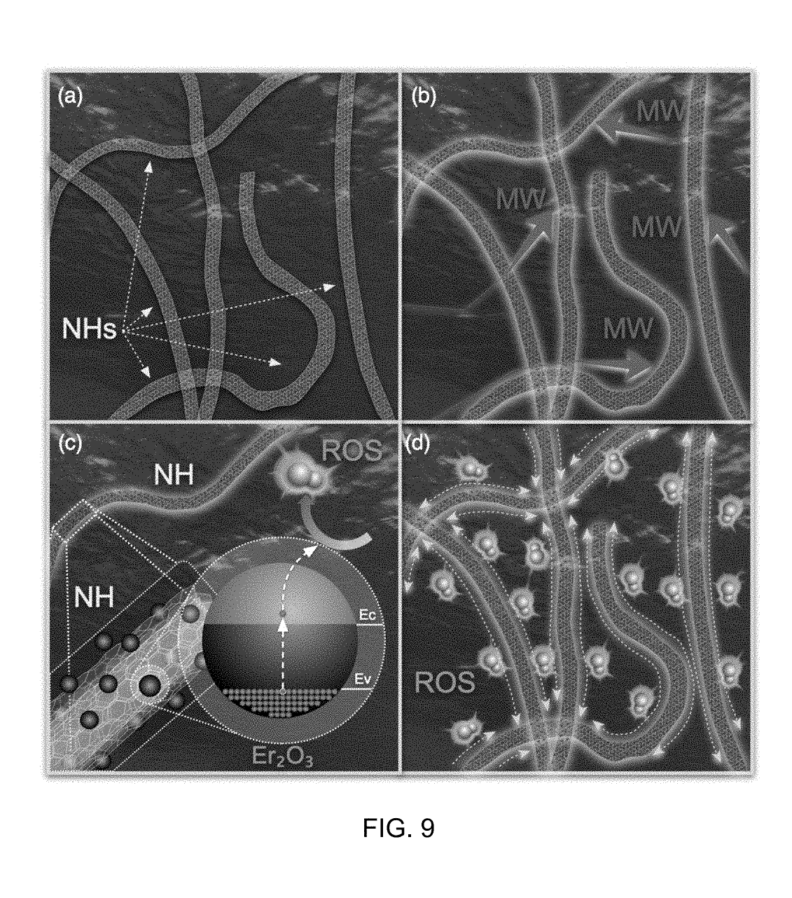

A remaining possible mechanism for disinfection is extracellular ROS, which can be produced due to irradiation of the samples with an external energy source (i.e., MW). Formation of H₂O₂ species is measured as a surrogate for ROS generation in this example (FIG. 8). When irradiated with MW, NH-1 produces at least two times higher H₂O₂ (8.71 μM) compared to the unirradiated case (4.46 and at least 7 times higher compared to the control samples (i.e., Er salt, Er oxide, and MWNTs) as shown in FIG. 8, panel a. NH-1 (16:1 molar ratio) is the most effective of the 3 NHs synthesized in producing H₂O₂ (FIG. 8, panel b). The increase in Er loading on MWNTs negatively correlates with the ROS production ability, as presented in FIG. 7, panel b. NH-2 and NH-3 do not produce significant amounts of H₂O₂ as compared to NH-1. Balance between MW absorption ability of the MWNTs with electron donation capacity of the metal oxides is necessary to achieve enhanced disinfection efficiency. Generation of ROS is thus the likely mechanism of inactivation of P. aeruginosa in this example (FIG. 9).

Possible ROS-Generation Mechanism.

MW absorption ability of MWNTs likely allows for the weak and otherwise dissipated MW energy to be localized around the tubular surfaces (FIG. 9, panels a and b). It is also reported that modification of the electromagnetic properties of MWNTs as a consequence of the hybridization with Er oxide, can results in improved MW absorbing abilities. The absorbed MW energy is then likely transferred to the neighboring metal oxide nanocrystals, which can utilize it to energize their electrons and cause charge separation (FIG. 9, panel c), i.e., electron-hole pair generation (details below). Introduction of ‘hot electrons’ into surrounding solvent medium can result in energized and temporal oxygen species or ROS formation (FIG. 8). Additionally, MWNTs used as the backbone of the NHs, are an exceptional vehicle for achieving charge transfer and transport (i.e., electron and hole transport) over a large specific surface area (50 to 1315 m²/g). This property also facilitates in ROS generation by the NHs when irradiated with MW (FIG. 9, panel d).

It is possible that generated ROS are temporal in nature and undergo a series of consecutive reactions where these acquire different chemical form (details below). H₂O₂ forms as a reaction product and appears in latter period in the reaction sequence (see below). Production of H₂O₂ in this example is thus likely a result of electron donation from the NHs when irradiated with MW and production of molecular superoxide radical. It is to be noted that formation of other ROS is yet to be determined, which will further elucidate the kinetics of oxygen species formation and their subsequent effects in disinfection. Electron spin resonance spectroscopy with appropriate spin traps can be utilized to determine all ROS generated in this disinfection process.

Environmental Implications.

This is the first investigation that has developed a nano-scale heterostructure, effective in harnessing and utilizing MW radiation for ROS production and disinfection. Synergistic abilities of MWNTs' MW absorption-ability with lanthanide series oxides' spectral conversion-capacity has allowed for successful charge-separation and generation of ROS. Effective disinfection via ROS generation with the lowest energy radiation (MW) at exceptionally low energy cost (0.0006 kWh) is potentially transformative. This simple yet elegant technological breakthrough will allow achieving a beneficial unintended use (of disinfection) from this widely distributed MW technology. The nascent benefits of MW, i.e., its ability to operate in absence of clear optical pathways (e.g., in turbid waters), its diffused presence deep into the societal fabric, and its potentially low economic and energetic footprints will allow for future implementation as an effective point-of-use water treatment solution. The authors acknowledge challenges that this technology will need to overcome to be the panacea and serve as a platform for disinfection processes in the future. Factors such as costs of the technology as compared to proven existing disinfection processes, treatable volume of water, material lifespan, and effectiveness of treating water with a wide range of physical and chemical characteristics are yet to be determined. Mode of application of the material to achieve an effective operational and maintenance feat and systematic evaluation of nano environmental health and safety issues have also to be determined. Once this technology is fully developed, it can potentially be transformative to impact a global population by gaining them access to safe drinking water.

TABLE 1
Loading ratios of the 3 NHs

| | | Amount | Amount | |
|---|---|---|---|---|
| | | of MWNTs | of salt* | Molar Ratio |
| No. | Name | (mg) | (mg) | (C:Er³⁺) |
| 1 | NH-1 | 50 | 115 | 16.04:1 |
| 2 | NH-2 | 50 | 230 | 8.02:1 |
| 3 | NH-3 | 50 | 460 | 4.01:1 |

*Erbium salt: Er(NO₃)₃•5H₂O

TABLE 2
EDX elemental composition of the 3 NHs synthesized.

| | Average Weight % | | |
|---|---|---|---|
| Element | NH-1 | NH-2 | NH-3 |
| Carbon | 41.36 | 23.82 | 7.47 |
| Erbium | 47.91 | 64.12 | 80.11 |
| Oxygen | 10.73 | 12.06 | 12.41 |
| Atomic ratios C:Er³⁺ | 0.86 | 0.37 | 0.09 |

TABLE 3
Summary of XPS data and Weight % of elements.

| | Weight % | | |
|---|---|---|---|
| XPS Region | NH-1 | NH-2 | NH-3 |
| C 1s | 49.08 | 35.71 | 12.90 |
| Er 4d | 38.16 | 49.35 | 69.13 |
| O 1s | 12.76 | 14.94 | 17.97 |
| Atomic ratios C:Er³⁺ | 1.29 | 0.72 | 0.19 |

TABLE 4
Temperature increase after 20 s microwave
irradiation time at 10% power.

| | Initial | Final | Delta |
|---|---|---|---|
| | Temperature, | Temperature, | Temp, |
| | ° C. | ° C. | ° C. |
| DI | 22.10 | 23.27 | 1.17 ± 0.12 |
| MWNT | 23.23 | 24.03 | 0.80 ± 0.10 |
| Salt* | 23.27 | 24.37 | 1.10 ± 0.17 |
| NH-1 | 23.40 | 25.50 | 2.10 ± 0.30 |
| NH-2 | 23.67 | 24.87 | 1.20 ± 0.17 |
| NH-3 | 23.33 | 24.37 | 1.03 ± 0.06 |

*Erbium salt: Er(NO₃)₃•5H₂O

ROS Generation.

Oxidative stress is one of the key mechanisms causing antimicrobiality when nanoparticles interact with bacteria. Such stresses are caused by an imbalance between damaging oxidants (e.g., H₂O₂ and OH.) and protective antioxidants (e.g., vitamin C and glutathione) within a nano-bio system. ROS may be generated from surfaces of metal oxide nanocrystals. Oxygen can be activated to form ROS by both energy transfer and electron transfer processes. The former leads to the formation of singlet oxygen (¹O₂), while the latter results in the generation of superoxide (O₂.⁻), which undergoes further chemical transformation in water.

When illuminated, metal oxides such as ZnO and TiO₂, cause charge separation, generating a hole (h⁺) in the valence band (E_{V}) and an electron (e⁻) in the conduction band (E_{C}) (Table 5). Holes extract electrons from water and/or hydroxyl ions, generating OH.. Electrons reduce O₂ producing O₂.⁻ and other ROS in a cascade of consecutive reactions (Table 5).

TABLE 5
ROS generating reactions.

metal oxide + light → h⁺ + e⁻
H₂O + h⁺ → OH^{•} + H⁺; OH^{•} + H⁺ + e⁻ → H₂O
O₂ + e⁻ → O₂^{•-}
O₂^{•-} + H⁺ → HO₂^{•}
O₂^{•-} + H⁺ + e⁻ → H₂O₂
2HO₂^{•} → H₂O₂ + O₂
O₂ + 2H⁺ + 2e⁻ → H₂O₂
H₂O₂ + O₂^{•-} → OH^{•} + O₂ + OH⁻
H₂O₂ + e⁻ + H⁺ → H₂O + OH^{•}

¹O₂ can be generated indirectly from metal oxide nanoparticles via the oxidation of O₂.⁻ and when sufficient energy capable of reversing the spin on one of the unpaired electrons of O₂ is absorbed, primarily through an energy transfer process. Carbon-based photosensitizers (i.e. C₆₀ fullerenes) have been shown to absorb UV or visible electromagnetic radiation and transfer it to surrounding molecules, and thereby facilitate energy or electron transfer that lead to the formation of ¹O₂ or O₂.⁻, respectively. In particular, MWNTs can accept electrons and aid in ballistic transport along MWNT axes, making these carbon structures excellent candidates to scatter electrons with enhanced surface area.

Electronic Structure of Metal Oxides.

The band architecture of semiconductors can be used to understand the ROS generation mechanisms when comparing with redox potentials (E_{H}) of different ROS. The electronic structure of semiconductors is characterized by the band-gap (E_{G}), which is essentially an energy difference between the valence (E_{V}) and conduction (E_{C}) bands. Values of E_{G} for metal oxides are dependent on the growth method, crystal structure, and defects. Different values of E_{G} for TiO₂ (2.9-3.3 eV), SiO₂ (8-11 eV), ZnO (3.20-3.44 eV), and lanthanide series Er₂O₃ (1.4-3.26 eV) have been reported. When E_{G} is small (0-4 eV) the material is considered to be a semiconductor; whereas for materials with higher E_{G} values (e.g., 4-12 eV) are considered as insulators. Although E_{G} is reported extensively for different materials, there is a need for accurate measurements and/or theoretical estimations for the E_{G} and the band structure of most semiconductors. Furthermore, E_{V} and E_{C} values are often presented in ways that prevent a straight-forward comparison to the redox potentials of aqueous electrolytes. For instance, in materials science the band energy positions are expressed with respect to the Fermi level of the material, rather than to the absolute vacuum scale (AVS). On the other hand, geochemical and electrochemical literature reports standard redox potentials for aqueous redox couples and with respect to the normal hydrogen electrode (NHE).

In the context of electron transfer between semiconductors and aqueous redox species, it is important to identify the highest occupied molecular orbital (HOMO) and the lowest unoccupied molecular orbital (LUMO) in the semiconductor because those are the energy levels involved in the transfer. In most semiconductors, the energy states in the E_{V} are completely occupied whereas those in the E_{C} are empty. The Fermi level (E_{F}) represents the chemical potential of electrons in a semiconductor and can be considered as the absolute electronegativity (−χ) of a pristine semiconductor. The relationships between band edge energies (i.e., the bottom of E_{C} and the top of E_{V}) and electronegativity are shown in Eqs. 1 and 2.

E_{C}=−χ+0.5E_{G} (1)

E_{V}=−χ−0.5E_{G} (2)

Solution chemistry affects band edges, shifting them to higher or lower energy levels following a linear relation with respect to the solution's pH, according to the Nernstian relation (Eqs. 3 and 4).

E_{C}=−χ+0.5E_{C}+0.059(PZZP−pH) (3)

E_{V}=−χ−0.5E_{C}+0.059(PZZP−pH) (4)

where, PZZP is the point of zero zeta potential of the bulk oxide.

Thus, the values of conduction and valence band energies can be estimated using these set of equations. Table 6 presents a comparison of the calculated values of band edge energies for TiO₂, SiO₂, ZnO, and Er₂O₃ at neutral pH for values of PZZP, electronegativities, and band gap energies found in the literature.

TABLE 6
Calculated band edge energies of semiconductors at absolute
vacuum scale (AVS) and normal hydrogen electrode (NHE).

| Metal | | χ | | E_{C} (eV) | E_{V} (eV) | E_{C} (eV) | E_{V} (eV) |
|---|---|---|---|---|---|---|---|
| Oxide | PZZP | (eV) | E_{G} (eV)^{d} | AVS | AVS | NHE | NHE |
| SiO₂ | 2^{a} | 6.46^{a} | 8, 10.4, 11 | −1.86 ± 0.79 | −11.66 ± 0.79 | −2.65 ± 0.79 | 7.16 ± 0.79 |
| ZnO | 8.8^{a} | 5.75^{a} | 3.26, 3.35, 3.44 | −3.97 ± 0.04 | −7.32 ± 0.04 | −0.53 ± 0.04 | 2.82 ± 0.04 |
| TiO₂ | 5.8^{a} | 5.83^{a} | 2.9, 3.3, 3.75 | −4.24 ± 0.21 | −7.56 ± 0.21 | −0.26 ± 0.98 | 3.06 ± 0.21 |
| Er₂O₃ | 8.8^{b} | 2.96^{c} | 1.4, 3.26, 5.3^{c} | −0.19 ± 0.98 | −4.51 ± 0.98 | −3.31 ± 0.98 | 0.01 ± 0.98 |

^{a,b,c,d}values found in literature. The energy positions of band edges in the electrochemical scale can be converted as: E_{(NHE)} = −E_{(AVS)} − 4.5.

In nanoparticle-mediated photocatalysis, ROS generation is dictated by an interfacial electron transfer processes. Only metal-oxide NPs with E_{G} less than the incident photon energy (e.g., 3.1 eV [400 nm UV] and 12.4 eV [100 nm UV]) can be photo-excited. Thus, TiO₂ and Er₂O₃ with E_{G} values as reported in Table 6 could potentially be photo-excited by 365 nm UV light (3.4 eV), while ZnO and SiO₂ will not. The photo-excited electrons and holes can then react with an aqueous electron acceptor (i.e., molecular oxygen) and/or donor (i.e., water and hydroxyl ions), respectively to produce different ROS.

In order to determine if ROS generation reactions are thermodynamically favorable, one can align the calculated values of E_{V} and E_{C} from Table 6 and E_{H} values reported in Table 7. Such comparison shows evidences that the O₂.⁻ generation potentials from excited electrons donated from SiO₂, ZnO, TiO₂, and Er₂O₃ with E_{C} values of −2.65±0.79 eV, −0.53±0.04 eV, −0.26±0.98 eV and −3.31±0.98 eV, respectively are less than the value of E_{H} for the O₂/O₂.⁻ couple (−0.33 eV). Values of E_{C} for TiO₂ is greater than the E_{H} of O₂/O₂.⁻ (−0.33 eV); which indicates that at this pH, its reducing ability is insufficient to reduce O₂. For other species such as H₂O₂ generation, theoretical estimation shows that metal oxides with E_{V} values larger than E_{H} value of 0.94-1.06 eV at pH 7 with respect to NHE can produce this ROS. Thus, SiO₂ (7.16±0.79 eV), ZnO (2.82±0.04 eV), TiO₂ (3.06±0.21 eV), and Er₂O₃ (0.01±0.98 eV) can possibly generate H₂O₂. Similarly, OH. generation might also be theoretically achieved by metal oxides with E_{V} values larger than E_{H} 2.2 eV at pH 7 with respect to NHE. Thus, SiO₂, ZnO, and TiO₂, might theoretically oxidize H₂O into OH., while Er₂O₃ would not.

TABLE 7
Standard one-electron reduction potentials
(E_{H}) of ROS at pH 7 with respect to NHE.

| Couple* | E_{H} (eV) |
|---|---|
| OH^{•}, H⁺/H₂O | 2.31 |
| HOO^{•}, H⁺/H₂O₂ | 1.06 |
| O₂^{•-}, 2H⁺/H₂O₂ | 0.94 |
| O₂(¹Δg)/O₂^{•-} | 0.65 |
| H₂O₂, H⁺/H₂O, OH^{•} | 0.32 |
| O₂/O₂^{•-} | −0.33 |
| O₂, H⁺/HO₂^{•} | −0.46 |
| H₂O/e_{aq}⁻ | −2.87 |

*Listed in order from highly oxidizing to highly reducing.

### REFERENCES

Stoneman, P.; Diederen, P. Technology diffusion and public policy. The Economic Journal 1994, 104 (425), 918.
Istepanian, R. S. H.; Jovanov, E.; Zhang, Y. T. Guest Editorial Introduction to the Special Section on M-Health: Beyond Seamless Mobility and Global Wireless Health-Care Connectivity. IEEE Trans. Inform. Technol. Biomed. 2004, 8 (4), 405-414.
Lester, R. T.; Ritvo, P.; Mills, E. J.; Kariri, A.; Karanja, S.; Chung, M. H.; Jack, W.; Habyarimana, J.; Sadatsafavi, M.; Najafzadeh, M.; et al. Effects of a mobile phone short message service on antiretroviral treatment adherence in Kenya (WelTel Kenyal): a randomised trial. Lancet 2010, 376 (9755), 1838-1845.
Shannon, M. A.; Bohn, P. W.; Elimelech, M.; Georgiadis, J. G.; Marinas, B. J.; Mayes, A. M. Science and technology for water purification in the coming decades. Nature 2008, 452 (7185), 301-310.
Richardson, S. D.; Thruston, A. D., Jr; Caughran, T. V.; Chen, P. H.; Collette, T. W.; Schenck, K. M.; Lykins, B. W., Jr; Rav-Acha, C.; Glezer, V. Identification of New Drinking Water Disinfection by-Products from Ozone, Chlorine Dioxide, Chloramine, and Chlorine. In Environmental Challenges; Springer Netherlands: Dordrecht, 2000; pp 95-102.
Deborde, M.; von, G. U. Reactions of chlorine with inorganic and organic compounds during water treatment—Kinetics and mechanisms: A critical review. Water Research 2008, 42 (1-2), 13-51.
Aieta, E. M.; Berg, J. D. A review of chlorine dioxide in drinking water treatment. Journal American Water Works Association 1986, 78 (6), 62-72.
Hoigne, J.; Bader, H. The role of hydroxyl radical reactions in ozonation processes in aqueous solutions. Water Research 1976, 10 (5), 377-386.
Richardson, S. D. Disinfection by-products and other emerging contaminants in drinking water. TrAC Trends in Analytical Chemistry 2003, 22 (10), 666-684.
Wolfe, R. L. Ultraviolet disinfection of potable water. Environ. Sci. Technol. 1990, 24 (6), 768-773.
Tobin, R. S.; Smith, D. K.; Horton, A.; Armstrong, V. C. Methods for testing the efficacy of ultraviolet light disinfection devices for drinking water. Journal American Water Works Association 1983, 75 (9), 481-484.
Zhou, H.; Smith, D. W. Advanced technologies in water and wastewater treatment. Can. J. Civ. Eng. 2001, 28 (51), 49-66.
Christensen, J.; Linden, K. G. How particles affect UV light in the UV disinfection of unfiltered drinking water. Journal American Water Works Association 2003, 95 (4), 179-189.
Massé, D. I.; Masse, L.; Topp, E.; Seguin, G.; Ortega, L. M.; Scott, A.; Pariseau, É. Maintenance strategies for on-site water disinfection by ultraviolet lamps on dairy farms. Water Quality Research Journal of Canada 2011, 46 (1), 2-11.
Parrotta, M. UV disinfection of small groundwater supplies. Journal American Water Works Association 1998, 90 (2), 71-81.
Li, Q.; Mahendra, S.; Lyon, D. Y.; Brunet, L.; Liga, M. V.; Li, D.; Alvarez, P. J. J. Antimicrobial nanomaterials for water disinfection and microbial control: Potential applications and implications. Water Research 2008, 42 (18), 4591-4602.
Gumy, D.; Rincon, A. G.; Hajdu, R.; Pulgarin, C. Solar photocatalysis for detoxification and disinfection of water: Different types of suspended and fixed TiO2 catalysts study. Solar Energy 2006, 80 (10), 1376-1381.
Adams, L. K.; Lyon, D. Y.; Alvarez, P. J. J. Comparative eco-toxicity of nanoscale TiO2, SiO2, and ZnO water suspensions. Water Research 2006, 40 (19), 3527-3532.
Kim, J.-H.; Kim, J.-H. Encapsulated Triplet-Triplet Annihilation-Based Upconversion in the Aqueous Phase for Sub-Band-Gap Semiconductor Photocatalysis. J. Am. Chem. Soc. 2012, 134 (42), 17478-17481.
Cates, E. L.; Wilkinson, A. P.; Kim, J.-H. Delineating Mechanisms of Upconversion Enhancement by Li+Codoping in Y 2SiO 5:Pr 3. J. Phys. Chem. C 2012, 116 (23), 12772-12778.
Wang, F.; Liu, X. Recent advances in the chemistry of lanthanide-doped upconversion nanocrystals. Chem. Soc. Rev. 2009, 38 (4), 976-989.
Zhou, B.; Shi, B.; Jin, D.; Liu, X. Controlling upconversion nanocrystals for emerging applications. Nature Nanotech 2015, 10 (11), 924-936.
Chen, J.; Zhao, J. X. Upconversion Nanomaterials: Synthesis, Mechanism, and Applications in Sensing. 2012, 12 (12), 2414-2435.
Li, X.; Zhang, F.; Zhao, D. Highly efficient lanthanide upconverting nanomaterials: Progresses and challenges. Nano Today 2013, 8 (6), 643-676.
Vázquez, E.; Prato, M. Carbon Nanotubes and Microwaves: Interactions, Responses, and Applications. 2009, 3 (12), 3819-3824.
Vergani, C.; Pavarina, A. C.; Ribeiro, D. G.; Dovigo, L. N.; Sanita, P. V. Microwave Assisted Disinfection Method in Dentistry; Chandra, U., Ed.; 2011; pp 63-89.
Mingos, D. M. P.; Baghurst, D. R. Tilden Lecture. Applications of microwave dielectric heating effects to synthetic problems in chemistry. Chem. Soc. Rev. 1991, 20 (1), 1-47.
Grandbois, M.; Beyer, M.; Rief, M.; Clausen-Schaumann, H.; Gaub, H. E. How strong is a covalent bond? Science 1999, 283 (5408), 1727-1730.
Keller, M. D.; Bellows, W. K.; Guillard, R. Microwave treatment for sterilization of phytoplankton culture media. Journal of Experimental Marine Biology and Ecology 1988, 117 (3), 279-283.
Neppelenbroek, K. H.; Pavarina, A. C.; Palomari Spolidorio, D. M.; Sgavioli Massucato, E. M.; Spolidorio, L. C.; Vergani, C. E. Effectiveness of microwave disinfection of complete dentures on the treatment of Candida-related denture stomatitis. J Oral Rehabil 2008, 35 (11), 836-846.
Dovigo, L. N.; Pavarina, A. C.; Ribeiro, D. G.; de Oliveira, J. A.; Vergani, C. E.; Machado, A. L. Microwave Disinfection of Complete Dentures Contaminated In Vitrowith Selected Bacteria. Journal of Prosthodontics 2009, 18 (7), 611-617.
Yeo, C. B.; Watson, I. A.; Stewart-Tull, D. E.; Koh, V. H. Heat transfer analysis of staphylococcus aureus on stainless steel with microwave radiation. J. Appl. Microbiol. 1999, 87 (3), 396-401.
Zimmermann, U.; Pilwat, G.; Riemann, F. Dielectric Breakdown of Cell Membranes. Biophysical Journal 1974, 14 (11), 881-899.
Das, D.; Sabaraya, I. V.; Aich, N.; Saleh, N. B. Aggregation kinetics of carbon nanotube and metal or metal oxide nanohybrids in aquatic environment, 250th National Meeting of the ACS, Aug. 16-20, 2015, Boston, Mass.
Guerfi, N.; Bourbia, O.; Achour, S. Study of Erbium Oxidation by XPS and UPS. MSF 2005, 480-481, 193-196.
Rigdon, W. A.; Huang, X. Carbon monoxide tolerant platinum electrocatalysts on niobium doped titania and carbon nanotube composite supports. Journal of Power Sources 2014, 272 (c), 845-859.
Miritello, M.; Savio, Lo, R.; Piro, A. M.; Franzo, G.; Priolo, F.; Iacona, F.; Bongiorno, C. Optical and structural properties of Er2O3 films grown by magnetron sputtering. J. Appl. Phys. 2006, 100 (1).
Aksel, S.; Eder, D. Catalytic effect of metal oxides on the oxidation resistance in carbon nanotube-inorganic hybrids. J. Mater. Chem. 2010, 20 (41), 9149-6.
Foster, H. A.; Sheel, D. W.; Sheel, P.; Evans, P.; Varghese, S.; Rutschke, N.; Yates, H. M. Antimicrobial activity of titania/silver and titania/copper films prepared by CVD. Journal of Photochemistry and Photobiology A: Chemistry 2010, 216 (2-3), 283-289.
Dunlop, P. S. M.; Sheeran, C. P.; Byrne, J. A.; McMahon, M. A. S.; Boyle, M. A.; McGuigan, K. G. Inactivation of clinically relevant pathogens by photocatalytic coatings. Journal of Photochemistry and Photobiology A: Chemistry 2010, 216 (2-3), 303-310.
Lonnen, J.; Kilvington, S.; Kehoe, S. C.; Al-Touati, F.; McGuigan, K. G. Solar and photocatalytic disinfection of protozoan, fungal and bacterial microbes in drinking water. Water Research 2005, 39 (5), 877-883.
Chambers, B.; Afrooz, A. R. M. N.; Bae, S.; Aich, N.; Katz, L.; Saleh, N. B.; Kirisits, M. J. Effects of Chloride and Ionic Strength on Physical Morphology, Dissolution, and Bacterial Toxicity of Silver Nanoparticles. Environ. Sci. Technol. 2014, 48 (1), 761-769.
Abebe, L. S.; Su, Y.-H.; Guerrant, R. L.; Swami, N. S.; Smith, J. A. Point-of-Use Removal of Cryptosporidium parvum from Water: Independent Effects of Disinfection by Silver Nanoparticles and Silver Ions and by Physical Filtration in Ceramic Porous Media. Environ. Sci. Technol. 2015, 49 (21), 12958-12967.
Chen, Z.; Chen, H.; Hu, H.; Yu, M.; Li, F.; Zhang, Q.; Zhou, Z.; Yi, T.; Huang, C. Versatile Synthesis Strategy for Carboxylic Acid-functionalized Upconverting Nanophosphors as Biological Labels. J. Am. Chem. Soc. 2008, 130 (10), 3023-3029.
O'Toole, A.; Ricker, E. B.; Nuxoll, E. Thermal mitigation of Pseudomonas aeruginosa biofilms. Biofouling 2015, 31 (8), 665-675.
Kuchma, T. Synergistic effect of microwave heating and hydrogen peroxide on inactivation of microorganisms. J Microw Power Electromagn Energy 1998, 33 (2), 77-87.
Zhang, L.; Zhu, H.; Song, Y.; Zhang, Y.; Huang, Y. The electromagnetic characteristics and absorbing properties of multi-walled carbon nanotubes filled with Er2O3 nanoparticles as microwave absorbers. Materials Science and Engineering: B 2008, 153 (1-3), 78-82.
Guldi, D. M.; Rahman, G. M. A.; Zerbetto, F.; Prato, M. Carbon Nanotubes in Electron Donor-Acceptor Nanocomposites. Acc. Chem. Res. 2005, 38 (11), 871-878.
Peigney, A.; Laurent, C.; Flahaut, E.; Bacsa, R. R.; Rousset, A. Specific surface area of carbon nanotubes and bundles of carbon nanotubes. Carbon 2001, 39 (4), 507-514.
Stone, V.; Donaldson, K. Nanotoxicology—Signs of stress. Nature Nanotech 2006, 1 (1), 23-24.
Long, T. C.; Saleh, N. B.; Tilton, R. D.; Lowry, G. V.; Veronesi, B. Titanium Dioxide (P25) Produces Reactive Oxygen Species in Immortalized Brain Microglia (BV2): Implications for Nanoparticle Neurotoxicity †. Environ. Sci. Technol. 2006, 40 (14), 4346-4352.
Burello, E.; Worth, A. P. A theoretical framework for predicting the oxidative stress potential of oxide nanoparticles. Nanotoxicology 2011, 5 (2), 228-235.
Arguinzoniz, A. G.; Ruggiero, E.; Habtemariam, A.; Hernandez-Gil, J.; Salassa, L.; Mareque-Rivas, J. C. Light Harvesting and Photoemission by Nanoparticles for Photodynamic Therapy. Part. Part. Syst. Charact. 2013, 31 (1), 46-75.
Buettner, G. R. The Pecking Order of Free-Radicals and Antioxidants—Lipid-Peroxidation, Alpha-Tocopherol, and Ascorbate. Arch. Biochem. Biophys. 1993, 300 (2), 535-543.
Daimon, T.; Nosaka, Y. Formation and Behavior of Singlet Molecular Oxygen in TiO 2 Photocatalysis Studied by Detection of Near-Infrared Phosphorescence. J. Phys. Chem. C 2007, 111 (11), 4420-4424.
Hirakawa, K.; Hirano, T. Singlet oxygen generation photocatalyzed by TiO2 particles and its contribution to biomolecule damage. Chemistry Letters 2006, 35 (8), 832-833.
Sharma, P.; Jha, A. B.; Dubey, R. S.; Pessarakli, M. Reactive Oxygen Species, Oxidative Damage, and Antioxidative Defense Mechanism in Plants under Stressful Conditions. Journal of Botany 2012, 2012 (1), 1-26.
Brunet, L.; Lyon, D. Y.; Hotze, E. M.; Alvarez, P. J. J.; Wiesner, M. R. Comparative Photoactivity and Antibacterial Properties of C 60Fullerenes and Titanium Dioxide Nanoparticles. Environ. Sci. Technol. 2009, 43 (12), 4355-4360.
Strehlow, W. H.; Cook, E. L. Compilation of Energy Band Gaps in Elemental and Binary Compound Semiconductors and Insulators. Journal of Physical and Chemical Reference Data 1973, 2 (1), 163-200.
Xu, Y.; Schoonen, M. A. A. The absolute energy positions of conduction and valence bands of selected semiconducting minerals. American Mineralogist 2000, 85 (3-4), 543-556.
Butler, M. A.; Ginley, D. S. Prediction of Flatband Potentials at Semiconductor-Electrolyte Interfaces from Atomic Electronegativities. Journal of The Electrochemical Society 1978, 125 (2), 228-232.
Ozawa, M.; Hattori, M. Ultrasonic vibration potential and point of zero charge of some rare earth oxides in water. Journal of Alloys and Compounds 2006, 408-412, 560-562.
Dagenais, K.; Chamberlin, M.; Constantin, C. Modeling Energy Band Gap as a Function of Optical Electronegativity for Binary Oxides. Journal of Young Investigators 2013, 25 (3), 1-6.
Li, Y.; Zhang, W.; Niu, J.; Chen, Y. Mechanism of Photogenerated Reactive Oxygen Species and Correlation with the Antibacterial Properties of Engineered Metal-Oxide Nanoparticles. ACS Nano 2012, 6 (6), 5164-5173.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “‘1’ or ‘2’ or ‘3’ or ‘1 and 2’ or ‘1 and 3’ or ‘2 and 3’ or ‘1, 2 and 3’”.

Every formulation or combination of components described or exemplified can be used to practice the invention, unless otherwise stated. Specific names of materials are intended to be exemplary, as it is known that one of ordinary skill in the art can name the same material differently. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A microwave absorbing material comprising:
a carbon nanomaterial; and
a plurality of lanthanide series metal oxide nanocrystals hybridized to the carbon nanomaterial.

2. The microwave absorbing material of claim 1, wherein the lanthanide series metal oxide nanocrystals comprise erbium.

3. The microwave absorbing material of claim 1, wherein the lanthanide series metal oxide nanocrystals comprise erbium oxide.

4. The microwave absorbing material of claim 1, wherein the carbon nanomaterial is a multi-walled carbon nanotube, a single-walled carbon nanotube, graphene, a fullerene, a nanodiamond, or any combination of these.

5. The microwave absorbing material of claim 1, wherein the carbon nanomaterial is a microwave absorbing carbon nanomaterial.

6. The microwave absorbing material of claim 1, wherein a molar ratio of carbon to lanthanide series metal oxide in the carbon nanomaterial is selected from the range of about 1 to 1 to about 40 to 1.

7. The microwave absorbing material of claim 1, formed using a sol-gel process.

8. A method for making a microwave absorbing material, the method comprising:
forming a suspension of a carbon nanomaterial in a solvent;
adding a lanthanide series metal oxide precursor solution to the suspension to form a mixture;
removing solvent from the mixture to generate a residue comprising the carbon nanomaterial and lanthanide series metal or lanthanide series metal oxide from the lanthanide series metal oxide precursor; and
calcining the residue to form lanthanide series metal oxide nanocrystals and hybridize the lanthanide series metal oxide nanocrystals to the carbon nanomaterial, thereby forming the microwave absorbing material.

9. The method of claim 8, wherein calcining includes exposing the residue to a temperature of about 400° C.

10. The method of claim 8, wherein calcining includes heating the residue in a nitrogen atmosphere.

11. (canceled)

12. A method for generating reactive oxygen species, the method comprising:
contacting a microwave absorbing material with water, wherein the microwave absorbing material comprises:
a carbon nanomaterial; and
a plurality of metal oxide nanocrystals hybridized to the carbon nanomaterial;
exposing the microwave absorbing material to microwave radiation, wherein exposure of the microwave absorbing material to microwave radiation generates reactive oxygen species.

13. The method of claim 12, wherein the microwave radiation has a frequency selected from the range of 300 MHz to 300 GHz, wherein the microwave radiation has a frequency located in an ISM (industrial, scientific, medical) frequency band, or wherein the microwave radiation has a frequency of about 900 MHz or about 2.45 GHz.

14.-15. (canceled)

16. The method of claim 12, wherein exposing the microwave absorbing material to microwave radiation occurs for a duration of 1 minute or less.

17. (canceled)

18. A method for disinfecting water, the method comprising:
contacting a microwave absorbing material with water containing a pathogen, wherein the microwave absorbing material comprises
a carbon nanomaterial; and
a plurality of metal oxide nanocrystals hybridized to the carbon nanomaterial;
exposing the microwave absorbing material to microwave radiation, wherein exposure of the microwave absorbing material to microwave radiation results in reduction of a concentration of the pathogen in the water.

19. The method of claim 18, wherein the water has one or more of a turbidity greater than 50 NTU (Nephelometric Turbidity Units), a concentration of natural organic matter greater than greater than 5 mg/L, or a hardness of greater than 60 ppm.

20.-21. (canceled)

22. The method of claim 18, wherein exposure of the microwave absorbing material to microwave radiation results in reduction of the concentration of the pathogen in the water by a factor of 10 or more.

23. The method of claim 18, wherein the microwave radiation has a frequency selected from the range of 300 MHz to 300 GHz, wherein the microwave radiation has a frequency located in an ISM (industrial, scientific, medical) frequency band, or wherein the microwave radiation has a frequency of about 900 MHz or about 2.45 GHz.

24. (canceled)

25. (canceled)

26. The method of claim 18, wherein exposing the microwave absorbing material to microwave radiation occurs for a duration of 1 minute or less.

27. The method of claim 18, wherein the pathogen is a bacterium or a virus.

28. The method of claim 18, wherein the pathogen is a bacterium of the species Pseudomonas aeruginosa, Escherichia coli, or Flavobacterium columnare.

29. (canceled)
